(19) United States
(12) Patent Application Publication
(10) Pub. No.: US 2016/0169058 A1
(43) Pub. Date: Jun. 16, 2016

(54) PISTON MACHINE

(71) Applicant: IBOS INNOVATIONS PTY LTD, Maroochydore, Queensland (AU)

(72) Inventors: Kenneth David BURROWS, Jimboomba (AU); Jack Zeljko JAKOVAC, Bulimba (AU); Jason Matthew JAKOVAC, Runcorn (AU)

(73) Assignee: IBOS Innovations Pty Ltd, Maroochydore, QL (AU)

(21) Appl. No.: 14/907,506

(22) PCT Filed: Jul. 25, 2014
(86) PCT No.: PCT/AU2014/050151

§ 371 Date: Jan. 25, 2016

(30) Foreign Application Priority Data
Jul. 26, 2013 (AU) 2013902775
Apr. 9, 2014 (AU) 2014901298

(51) Int. Cl. F01L 1/34; F02B 1/02

(52) U.S. Cl. CPC F01L 1/34; F02B 1/02

(57) ABSTRACT

A piston machine including: a crankshaft; a cylinder defining an internal chamber; a piston positioned in the chamber, the piston being connected to the crankshaft and being configured to reciprocate inside the chamber; a head attached to the cylinder and closing the chamber at an end opposing the piston. The head includes at least one port group including ports for allowing fluid communication between the chamber and a respective manifold; and for each port group, a valve arrangement coupled to the head, each valve arrangement including, a valve for operatively controlling fluid flow through the respective port and a bridge coupled to the valves, wherein movement of the bridge relative to the head causes synchronised operation of the valves; and, an actuator for causing the bridge to move based on the reciprocation of the piston.

### BACKGROUND OF THE INVENTION

The present invention relates to piston machines, particularly, but not exclusively, reciprocating engines powered by a pressurised gas such as air, or compressors as well as to valve arrangements for use in piston machines.

### DESCRIPTION OF THE PRIOR ART

Reciprocating engines, also commonly referred to as piston engines, are used to convert pressure applied to a reciprocating piston into rotation of a connected shaft. In internal combustion reciprocating engines, the pressure is provided by the combustion of fuel inside a cylinder in which the piston reciprocates. In other types of reciprocating engines, the pressure for powering the engine may be provided by supplying a pressurised gas directly into the cylinder. For example, steam engines are powered by heated and pressurised water vapour, and air engines are powered by compressed air.

Whilst air engines and other reciprocating engine types which are powered by a pressurised gas without relying on internal combustion often have reduced energy production capacities compared to similarly sized internal combustions engines, there are nevertheless a range of applications where these may be desirable, such as in situations where combustion would be unsafe or it is undesirable for combustion waste products to be emitted into the operating environment.

There has been growing interest in the use of compressed gas engines, and particularly air engines, as a source of motive power for automobiles. Typically, air engines will not generate any polluting emissions at the point of use, and are thus considered to provide a relatively clean alternative to internal combustion engines, assuming pressurised air can be efficiently produced by a compressor driven by a renewable power source or at least a power source which produces reduced emissions compared to an equivalent internal combustion engine.

U.S. Pat. No. 6,598,392 discloses an example of a compressed gas engine proposed for use as a power plant for small vehicles which can be powered by compressed gas rather than internal combustion. In particular, the compressed gas engine of this document includes a plurality of reciprocating pistons within cylinders, the pistons being driven by compressed gas from a source tank. Intake and exhaust valves selectively open to direct compressed gas to the piston to drive the piston, and to exhaust air, respectively.

Unfortunately, air engine powered automobiles proposed to date have generally had highly restrictive performance and/or range of operation. This may be attributed to inefficiencies in the design of the air engine design, physical limitations on the amount of compressed air that can be stored and its storage pressure.

Recent developments in this field have sought to address some of these problems, although the designs proposed by high profile air engine development companies such as Engineair Pty Ltd and Motor Development International S.A. (MDI) have still not provided sufficient improvements to make air engine powered automobiles commercially feasible to date, despite significant deviations from conventional reciprocating engine arrangements.

Furthermore, widespread adoption of air engine technology in automobiles is likely to require infrastructure for efficiently providing compressed air for recharging the automobile's supplies, which is not yet available.

Air engines may also be useful in allowing electrical power to be generated, such as in remote locations having no existing electricity or fuel distribution infrastructures, although similar issues with regard to design inefficiencies along with the storage and/or production of compressed air have limited practical applications in this regard.

In view of the above, there is still an unmet need for improved reciprocating engine technologies, particularly with regard to reciprocating engines powered by compressed gas.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In a first broad form the present invention seeks to provide a reciprocating engine including:
a) a crankshaft;
b) a cylinder defining an internal chamber;
c) a piston positioned in the chamber, the piston being connected to the crankshaft and being configured to reciprocate inside the chamber;
d) a head attached to the cylinder and closing the chamber at an end opposing the piston, the head including at least one port group including two or more ports for allowing fluid communication between the chamber and a respective manifold; and,
e) for each port group, a valve arrangement coupled to the head, each valve arrangement including:
   i) for each port of the port group, a valve for operatively controlling fluid flow through the respective port;
   ii) a bridge coupled to the valves, wherein movement of the bridge relative to the head causes synchronised operation of the valves; and,
   iii) an actuator for causing the bridge to move based on the reciprocation of the piston.

Typically the actuator includes a cam mounted on a camshaft that is rotationally coupled to the crankshaft, the cam being configured to control the movement of the bridge depending on a rotational position of the crankshaft.

Typically the bridge includes a cam follower for engaging the cam.

Typically the actuator causes the bridge to move away from the head.

Typically each valve arrangement includes at least one biasing member for biasing the bridge towards the head.

Typically the biasing member is a spring.

Typically at least one valve arrangement is configured such that movement of the bridge away from the head causes the valves to close the respective ports.

Typically the biasing member assists in moving the bridge towards the head to thereby cause the valves to open the respective ports.

Typically the at least one valve arrangement is configured such that movement of the bridge away from the head causes the valves to open the respective ports.

Typically the biasing member assists in moving the bridge towards the head to thereby cause the valves to close the respective ports.

Typically the actuator causes the bridge to move towards the head.

Typically the actuator causes the bridge to controllably move towards the head and away from the head based on the reciprocation of the piston.

Typically each valve includes:
a) an elongate stem, the stem being coupled to the bridge; and,
b) a plug at an end of the stem, the plug being for sealing an opening of the respective port to thereby close the port.

Typically the stem of each valve is radially supported by a valve guide positioned in the head.

Typically, for the valves of one of the valve arrangements, the valves are opened by being lifted by the bridge such that the plug moves into the head.

Typically the piston reciprocates in a stroke direction relative to the cylinder, and the bridge moves in the stroke direction to thereby cause the valves to move in the stroke direction.

Typically the valves are coupled to the bridge symmetrically with respect to a centre plane of the bridge.

Typically the engine includes:
a) in the head:
   i) an inlet port group for allowing fluid communication between the chamber and an inlet manifold; and,
   ii) an exhaust port group for allowing fluid communication between the chamber and an exhaust manifold;
b) an inlet valve arrangement including inlet valves for controlling fluid flow through respective inlet ports of the inlet port group and an inlet bridge coupled to the inlet valves; and,
c) an exhaust valve arrangement including exhaust valves for controlling fluid flow through respective exhaust ports of the exhaust port group and an exhaust bridge coupled to the inlet valves.

Typically the inlet valves are configured to open when the inlet bridge is moved away from the head and the exhaust valves are configured to close when the exhaust bridge is moved away from the head.

Typically the inlet bridge is moved away from the head by an inlet cam and the exhaust bridge is moved away from the head by an exhaust cam.

Typically the inlet cam and the exhaust cam are mounted on a single cam shaft, the cam shaft being coupled to the crankshaft.

Typically the inlet valve assembly includes at least one inlet biasing member for urging the inlet bridge towards the head to thereby bias the inlet valves in a closed position.

Typically the exhaust valve assembly includes at least one exhaust biasing member for urging the exhaust bridge towards the head to thereby bias the exhaust valves in an open position.

Typically the inlet valves are configured to close when the inlet bridge is moved away from the head and the exhaust valves are configured to close when the exhaust bridge is moved away from the head.

Typically the inlet valve assembly includes at least one inlet biasing member for urging the inlet bridge towards the head to thereby bias the inlet valves in an open position.

Typically the exhaust valve assembly includes at least one exhaust biasing member for urging the exhaust bridge towards the head to thereby bias the exhaust valves in an open position.

Typically the exhaust port group includes a greater number of ports compared to the inlet group.

Typically a total exhaust flow area through the exhaust ports of the exhaust port group is greater than a total inlet flow area through the inlet ports of the inlet port group.

Typically the piston has a concave piston face.

Typically the crankshaft is supported inside the engine using roller bearings.

Typically the piston includes piston seals for forming a seal between the piston and walls of the cylinder.

Typically the engine includes a plurality of cylinders, each cylinder having a respective piston, head and valve assembly.

Typically the same piston, head and valve assemblies are used for each cylinder of the plurality of cylinders.

Typically the valve assemblies are configured such that the inlet ports for at least one cylinder are open for all crankshaft rotational positions.

In a second broad form the present invention seeks to provide a power generation system including:
a) a gas compressor for receiving gas and pressurising the gas to thereby supply pressurised gas;
b) an engine according to any one of claims 1 to 34, the engine being configured to receive pressurised gas from the gas compressor such that the engine is driven by the pressurised gas.

Typically the system further includes an electrical power generator coupled to the engine.

Typically the electrical power generator is for supplying electrical power to at least one of:
a) an electrical load;
b) an electrical store;
c) an electric motor; and,
d) the gas compressor.

Typically the engine exhausts exhaust gas having an exhaust temperature lower than ambient temperature, the exhaust gas being used for at least one of:
a) cooling;
b) cooling of equipment;
c) refrigeration; and,
d) air-conditioning.

Typically the gas compressor is driven by an internal combustion engine.

Typically the internal combustion engine is cooled by exhaust gas exhausted by the engine.

In a third broad form the present invention seeks to provide a vehicle power plant including a power generation system as described above.

Typically the vehicle includes wheels and the engine is mechanically coupled to a drive train to thereby drive wheels of the vehicle.

Typically the system includes a store for storing any pressurised gas that is not used to drive the engine when the pressurised gas is supplied by the gas compressor, the store being configured to controllably supply pressurised gas to the engine.

In a fourth broad form the present invention seeks to provide a pressurised gas engine configured to be driven by pressurised gas, the pressurised gas engine including:
a) a crankshaft;
b) a cylinder defining an internal chamber;
c) a piston positioned in the chamber, the piston being connected to the crankshaft and being configured to reciprocate inside the chamber;
d) a head attached to the cylinder and closing the chamber at an end opposing the piston, the head including at least one port group including two or more ports for allowing fluid communication between the chamber and a respective manifold; and,
e) for each port group, a valve arrangement coupled to the head, each valve arrangement including:
   i) for each port of the port group, a valve for operatively controlling fluid flow through the respective port;
   ii) a bridge coupled to the valves, wherein movement of the bridge relative to the head causes synchronised operation of the valves; and,
   iii) an actuator for causing the bridge to move based on the reciprocation of the piston.

Typically the pressurised gas engine includes:
a) in the head:
   i) an inlet port group for allowing fluid communication of pressurised gas between the chamber and an inlet manifold; and,
   ii) an exhaust port group for allowing fluid communication of exhaust gas between the chamber and an exhaust manifold;
b) an inlet valve arrangement including inlet valves for controlling pressurised gas flow through respective inlet ports of the inlet port group and an inlet bridge coupled to the inlet valves; and,
c) an exhaust valve arrangement including exhaust valves for controlling exhaust gas flow through respective exhaust ports of the exhaust port group and an exhaust bridge coupled to the exhaust valves.

In a fifth broad form the present invention seeks to provide an internal combustion engine including:
a) a crankshaft;
b) a cylinder defining an internal chamber;
c) a piston positioned in the chamber, the piston being connected to the crankshaft and being configured to reciprocate inside the chamber;
d) a head attached to the cylinder and closing the chamber at an end opposing the piston, the head including at least one port group including two or more ports for allowing fluid communication between the chamber and a respective manifold; and,
e) for each port group, a valve arrangement coupled to the head, each valve arrangement including:
   i) for each port of the port group, a valve for operatively controlling fluid flow through the respective port;
   ii) a bridge coupled to the valves, wherein movement of the bridge relative to the head causes synchronised operation of the valves; and,
   iii) an actuator for causing the bridge to move based on the reciprocation of the piston.

Typically the internal combustion engine includes:
a) in the head:
   i) an inlet port group for allowing fluid communication of a mixture of fuel and air between the chamber and an inlet manifold; and,
   ii) an exhaust port group for allowing fluid communication of exhaust gases between the chamber and an exhaust manifold;
b) an inlet valve arrangement including inlet valves for controlling the flow of the mixture of fuel and air through respective inlet ports of the inlet port group and an inlet bridge coupled to the inlet valves; and,
c) an exhaust valve arrangement including exhaust valves for controlling the flow of exhaust gases through respective exhaust ports of the exhaust port group and an exhaust bridge coupled to the exhaust valves.

Typically the internal combustion engine includes at least one of:
a) an ignition source;
b) a glow plug; and,
c) a fuel injector.

In a sixth broad form the present invention seeks to provide a reciprocating engine including:
a) a crankshaft;
b) a cylinder defining an internal chamber
c) a piston positioned in the chamber, the piston being connected to the crankshaft and being configured to reciprocate inside the chamber;
d) a head attached to the cylinder and closing the chamber at an end opposing the piston, the head including a port for allowing fluid communication between the chamber and a respective manifold; and,
e) a valve arrangement including:
   i) a valve for operatively controlling fluid flow through the port;
   ii) a bridge coupled to the valve, wherein movement of the bridge in a first direction causes the valve to close and movement of the bridge in a second direction causes the valve to open;
   iii) a closing actuator for causing the bridge to move in the first direction based on the reciprocation of the piston, to thereby positively close the valve; and,
   iv) at least one biasing member for biasing the bridge towards the second direction.

Typically the valve arrangement is configured so that the biasing member causes the valve to open when the closing actuator is not being used to positively close the valve.

Typically the closing actuator includes a cam mounted on a camshaft that is rotationally coupled to the crankshaft, the cam being configured to control the movement of the bridge depending on a rotational position of the crankshaft, the bridge including a cam follower for engaging the cam.

Typically the bridge includes a first bridge portion to which the valve is coupled and a second bridge portion including the cam follower.

Typically the bridge defines a cavity between the first bridge portion and the second bridge portion, the camshaft extending through the cavity.

Typically each biasing member is a spring coupled to the bridge.

Typically each spring is coupled to the bridge so that the spring is compressed when the bridge is moved in the first direction using the closing actuator to positively close the valve so that the compressed spring urges the bridge in the second direction to thereby open the valve when the closing actuator is not being used to positively close the valve.

Typically each spring is mounted on a stud extending outwardly from the head.

Typically the valve arrangement includes a pair of biasing members arranged symmetrically about the valve.

Typically the movement of the bridge in the first direction involves the bridge moving away from the head and the movement of the bridge in the second direction involves the bridge moving towards the head.

Typically the valve arrangement includes two or more valves coupled to the bridge, each valve being for operatively controlling fluid flow through a respective port, whereby movement of the bridge causes synchronised operation of the two or more valves.

Typically the engine is a pressurised gas engine configured to be driven by compressed gas.

Typically the engine is an internal combustion engine and further includes at least one of:
a) an ignition source;
b) a glow plug; and,
c) a fuel injector.

Typically the valve arrangement further includes an opening actuator for causing the bridge to move in the second direction based on the reciprocation of the piston, to thereby positively open the valve.

Typically the valve arrangement includes a seal breaking actuator for causing the bridge to move in the second direction to positively break a seal between the port and the valve after the valve is closed.

Typically the closing actuator includes a first cam mounted on a camshaft that is rotationally coupled to the crankshaft and the seal breaking actuator includes a second cam mounted on the same camshaft, the first and second cams being configured to control the movement of the bridge depending on a rotational position of the crankshaft.

Typically the first cam includes a first cam lobe and the second cam includes a second cam lobe, and wherein upon rotation of the camshaft, the first cam lobe urges the bridge in the first direction to thereby positively close the valve and the second cam lobe urges the bridge in the second direction to positively break the seal.

Typically the bridge includes a first cam follower for engaging the first cam and a second cam follower for engaging the second cam.

Typically the bridge includes:
a) a first bridge portion to which the valve is coupled, the first bridge portion including the second cam follower; and,
b) a second bridge portion including the first cam follower.

Typically the camshaft extends between the first and second bridge portions.

Typically the valve arrangement is configured such that the biasing member cushions the closing of the valve.

In another broad form the present invention seeks to provide a piston machine including:
a) a rotating shaft;
b) a housing defining an internal chamber
c) a piston positioned in the chamber, the piston being connected to the shaft and being configured to move inside the chamber as the shaft rotates;
d) a port provided in the housing for allowing fluid communication between the chamber and a respective manifold; and,
e) a valve arrangement including:
   i) a valve for operatively controlling fluid flow through the port;
   ii) a bridge coupled to the valve, wherein movement of the bridge in a first direction causes the valve to close and movement of the bridge in a second direction causes the valve to open;
   iii) a closing actuator for causing the bridge to move in the first direction based on the reciprocation of the piston, to thereby positively close the valve; and,
   iv) at least one biasing member for biasing the bridge towards the second direction.

Typically the piston machine is at least one of a compressor and a reciprocating engine.

In another broad form the present invention seeks to provide a valve arrangement for use in a piston machine, the valve arrangement including:
a) a valve for operatively controlling fluid flow through a port;
b) a bridge coupled to the valve, wherein linear movement of the bridge in a first direction causes the valve to close and linear movement of the bridge in a second direction causes the valve to open;
c) a closing actuator including a rotatable cam having a cam lobe, and wherein upon rotation of the cam, the cam lobe urges the bridge in the first linear direction to thereby positively close the valve; and,
d) at least one biasing member for biasing the bridge in the second linear direction so that the at least one biasing member opens the valve when the valve is not positively closed by the actuator.

In another broad form the present invention seeks to provide a piston machine including:
a) a rotating shaft;
b) a housing defining an internal chamber;
c) a piston positioned in the chamber, the piston being connected to the shaft and being configured to move inside the chamber as the shaft rotates;
d) a head attached to the cylinder and closing the chamber at an end opposing the piston, the head including at least one port group including two or more ports for allowing fluid communication between the chamber and a respective manifold;
and,
e) for each port group, a valve arrangement coupled to the head, each valve arrangement including:
   i) for each port of the port group, a valve for operatively controlling fluid flow through the respective port;
   ii) a bridge coupled to the valves, wherein movement of the bridge relative to the head causes synchronised operation of the valves; and,
   iii) an actuator for causing the bridge to move.

In one broad form the present invention seeks to provide a valve arrangement for use in a piston machine, the valve arrangement including:
a) a valve for operatively controlling fluid flow through a port;
b) a bridge coupled to the valve, wherein linear movement of the bridge in a first direction causes the valve to close and linear movement of the bridge in a second direction causes the valve to open;
c) a closing actuator including a rotatable first cam having a first cam lobe, and wherein upon rotation of the first cam, the first cam lobe urges the bridge in the first linear direction to thereby positively close the valve; and,
d) an opening actuator for causing the bridge to move in the second direction to thereby at least positively open the valve.

Typically the valve arrangement includes a first cam follower mounted on the bridge, the first cam follower cooperating with the first cam to cause movement of the bridge in the first linear direction.

Typically the first cam is positioned between the first cam follower and the valve.

Typically the first cam lobe urges the first cam follower in the first linear direction away from the valve.

Typically the first cam follower is movably mounted to the bridge.

Typically the first cam follower is urged in the second direction relative to the bridge by a biasing spring.

Typically a position of the first cam follower in the first or second direction is adjusted to adjust a degree of valve lift.

Typically the opening actuator includes a rotatable second cam having a second cam lobe, and wherein upon rotation of the second cam, the second cam lobe urges the bridge in the second linear direction to thereby positively open the valve.

Typically the valve arrangement includes a second cam follower mounted on the bridge, the second cam follower cooperating with the second cam to cause movement of the bridge in the second linear direction.

Typically the second cam follower is positioned between the second cam and the valve.

Typically the second cam is mounted coaxially and rotationally invariant with the first cam.

Typically valve arrangement includes first and second cams mounted on a common camshaft.

Typically valve arrangement includes at least two first cams spaced apart along a common camshaft, the at least two first cams cooperating with corresponding at least two first cam followers mounted on the bridge.

Typically valve arrangement includes at least two second cams spaced apart along a common camshaft, the at least two second cams cooperating with corresponding at least two second cam followers mounted on the bridge.

Typically valve arrangement includes a plurality of first cams spaced apart along a common camshaft.

Typically the second cam lobe further restricts movement of the bridge in the first linear direction when first cam lobe is not urging the bridge in the first linear direction.

Typically the opening actuator includes a spring for biasing the valve in the second linear direction.

Typically the bridge includes first and second bridge portions

Typically the first and second bridge portions define an opening therebetween, a camshaft extending through the opening in use.

Typically the valve is coupled to the first bridge portion and wherein the valve arrangement includes a first cam follower mounted on the second bridge portion.

Typically the valve arrangement includes a second cam follower coupled to the first bridge portion.

Typically the valve arrangement includes at least one cam and cam follower laterally offset from the bridge.

Typically the valve arrangement includes a plurality of valves, bridges, and opening actuators in a spaced apart arrangement, each opening actuator including at least one first cam, each first cam being mounted on a common camshaft.

In another broad form the present invention seeks to provide a valve arrangement for use in a piston machine, the valve arrangement including:
a) a valve for operatively controlling fluid flow through a port;
b) a bridge coupled to the valve, wherein linear movement of the bridge in a first direction causes the valve to close and linear movement of the bridge in a second direction causes the valve to open; and,
c) a closing actuator including a rotatable cam having a cam lobe that engages a cam follower on the bridge, and wherein upon rotation of the cam, the cam lobe urges the cam follower and hence bridge in the first linear direction to thereby positively close the valve, wherein the cam is positioned between the cam follower and the valve.

The above broad forms of the invention and their respective features can be used independently, in conjunction or interchangeably and reference to respective broad forms is not intended to be limiting.

### BRIEF DESCRIPTION OF THE DRAWINGS

An example of the present invention will now be described with reference to the accompanying drawings, in which:—

FIG. 1A is a schematic perspective view of a first example of a reciprocating engine having a first crankshaft rotational position;

FIG. 1B is a schematic perspective view of the reciprocating engine of FIG. 1A having a second crankshaft rotational position;

FIG. 1C is a schematic underside perspective view of the head of the reciprocating engine as shown in FIG. 1B;

FIG. 1D is a schematic top view of the reciprocating engine of FIG. 1A;

FIG. 1E is a schematic cross section view of the reciprocating engine of FIG. 1A at section A-A′ indicated on FIG. 1D, showing inlet valve positions at the first crankshaft rotational position;

FIG. 1F is a schematic cross section view of the reciprocating engine of FIG. 1A at section B-B′ indicated on FIG. 1D, showing exhaust valve positions at the first crankshaft rotational position;

FIG. 1G is a schematic cross section view of the reciprocating engine of FIG. 1B at section A-A′ indicated on FIG. 1D, showing inlet valve positions at the second crankshaft rotational position;

FIG. 1H is a schematic cross section view of the reciprocating engine of FIG. 1B at section B-B′ indicated on FIG. 1D, showing exhaust valve positions at the second crankshaft rotational position;

FIGS. 1I to 1P are schematic cross section views of the reciprocating engine of FIG. 1B at section C-C indicated on FIG. 1D, showing respective inlet valve and exhaust valve positions at different crankshaft rotational positions;

FIG. 2A is a schematic front perspective view of an example of an air engine having a V4 configuration;

FIG. 2B is a schematic rear perspective view of the air engine of FIG. 2A;

FIG. 2C is a schematic front perspective view of the air engine of FIG. 2A with a number of covers installed;

FIG. 2D is a schematic bottom perspective view of the air engine of FIG. 2A with the crankcase removed to expose the crankshaft;

FIG. 2E is a schematic cross section view of one of the cylinders of the air engine of FIG. 2A;

FIG. 3A is a schematic front perspective view of a head and respective valve assemblies of the engine of FIG. 2A;

FIG. 3B is a schematic front view of the head and the valve assemblies of FIG. 3A;

FIG. 3C is a schematic side view of the head and the valve assemblies of FIG. 3A;

FIG. 3D is a schematic bottom perspective view of the head and the valve assemblies of FIG. 3A;

FIG. 3E is a schematic bottom perspective view of the valve assemblies of FIG. 3A, with the head removed;

FIG. 4A is a schematic side view showing a first piston and respective valves of the air engine of FIG. 2A, in which the first piston approaches a top dead centre position;

FIG. 4B is a schematic front view of the first piston of FIG. 4B;

FIG. 4C is a schematic side view showing a second piston and respective valves of the air engine of FIG. 2A, in which the second piston approaches a 90° after top dead centre position;

FIG. 4D is a schematic front view of the second piston of FIG. 4C;

FIG. 4E is a schematic side view showing a third piston and respective valves of the air engine of FIG. 2A, as the third piston approaches a 180° after top dead centre position;

FIG. 4F is a schematic front view of the third piston of FIG. 4E;

FIG. 4G is a schematic side view showing a fourth piston and corresponding valves of the air engine as shown in FIG. 4A, as the fourth piston approaches a 270° after top dead centre position;

FIG. 4H is a schematic front view of the fourth piston of FIG. 4G;

FIG. 5A is a valve timing diagram for the first piston of the air engine as shown in FIG. 4A, with reference to an absolute crank angle;

FIG. 5B is a valve timing diagram for the second piston of the air engine as shown in FIG. 4C, with reference to an absolute crank angle;

FIG. 5C is a valve timing diagram for the third piston of the air engine as shown in FIG. 4C, with reference to an absolute crank angle;

FIG. 5D is a valve timing diagram for the fourth piston of the air engine as shown in FIG. 4D, with reference to an absolute crank angle;

FIG. 6A is a schematic top perspective view of a head of the air engine of FIG. 2A;

FIG. 6B is a schematic bottom perspective view of the head of FIG. 6A;

FIG. 6C is a schematic cross section view of the head of FIG. 6A;

FIG. 7A is a schematic top perspective view of an inlet bridge of the air engine of FIG. 2A;

FIG. 7B is a schematic bottom perspective view of the inlet bridge of FIG. 7A;

FIG. 8A is a schematic top perspective view of an exhaust bridge of the air engine of FIG. 2A;

FIG. 8B is a schematic bottom perspective view of the exhaust bridge of FIG. 8A;

FIG. 9A is a schematic top perspective view of an inlet valve of the air engine of FIG. 2A;

FIG. 9B is a schematic bottom perspective view of the inlet valve of FIG. 9A;

FIG. 10A is a schematic top perspective view of an exhaust valve of the air engine of FIG. 2A;

FIG. 10B is a schematic bottom perspective view of the exhaust valve of FIG. 10A;

FIG. 11A is a schematic top perspective view of a valve guide of the air engine of FIG. 2A;

FIG. 11B is a schematic bottom perspective view of the valve guide of FIG. 11A;

FIG. 12A is a schematic perspective view of a crankshaft of the air engine of FIG. 2A;

FIG. 12B is a schematic front view of the crankshaft of FIG. 12A;

FIG. 13 is a schematic perspective view of a camshaft of the air engine of FIG. 2A;

FIG. 14A is a schematic perspective view of an example of an internal combustion engine;

FIG. 14B is a schematic underside perspective view of the head of the internal combustion engine as shown in FIG. 14A;

FIG. 14C is a schematic cross section view of the internal combustion engine of FIG. 1A, showing respective inlet valve and exhaust valve positions when the piston is at a top dead centre position;

FIG. 14D is a schematic cross section view of the internal combustion engine of FIG. 1A, showing respective inlet valve and exhaust valve positions when the piston is at a position partway along an exhaust stroke;

FIG. 15A is a schematic end view of an example of a valve arrangement and head of a reciprocating engine;

FIG. 15B is a schematic side view of the valve arrangement and head of FIG. 15A;

FIG. 16 is a schematic side view of another example of a valve arrangement and head similar to that of FIG. 15A but having two valves coupled to the bridge;

FIGS. 17A to 17C are schematic cross section views of a compressor, showing respective inlet valve and exhaust valve positions at different shaft rotational positions;

FIG. 18A is a schematic end view of another example of a valve arrangement and head of a reciprocating engine;

FIG. 18B is a schematic side view of the valve arrangement and head of FIG. 18A;

FIG. 19A is a schematic side view of another example of a valve arrangement;

FIG. 19B is a schematic end view of the valve arrangement of FIG. 19A; and,

FIGS. 20A to 20C are schematic end views of the valve arrangement of FIG. 19A during rotation of the camshaft.

### DETAILED DESCRIPTION OF THE PREFERRED EMBODIMENTS

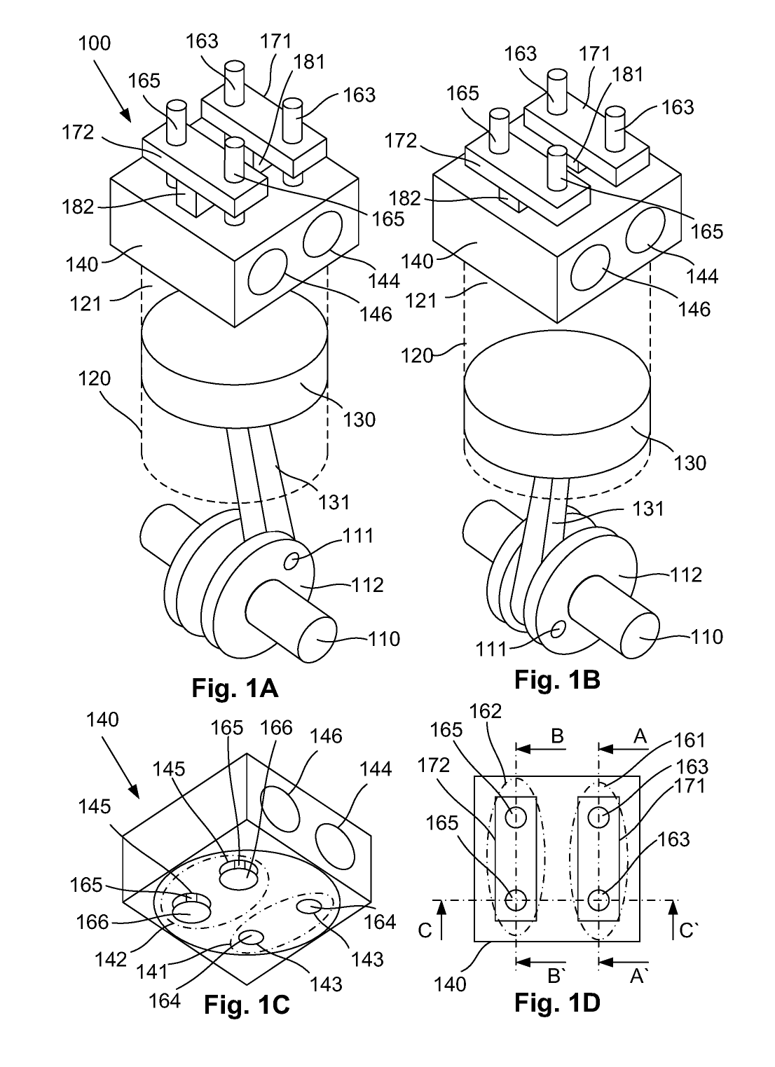

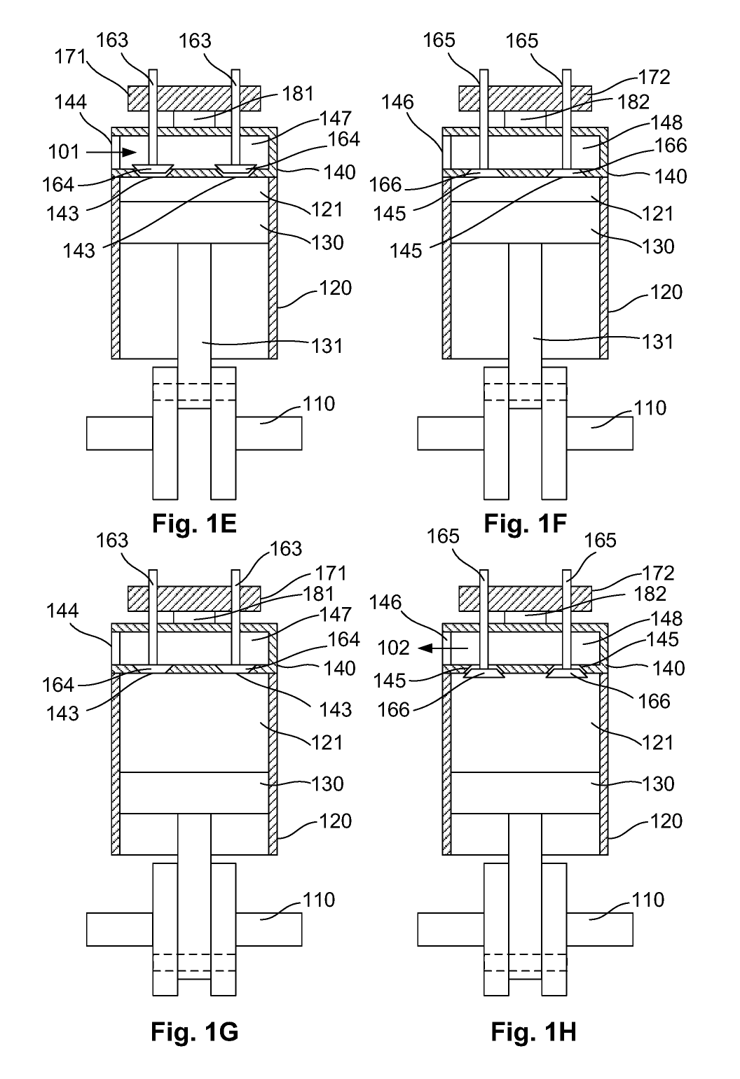

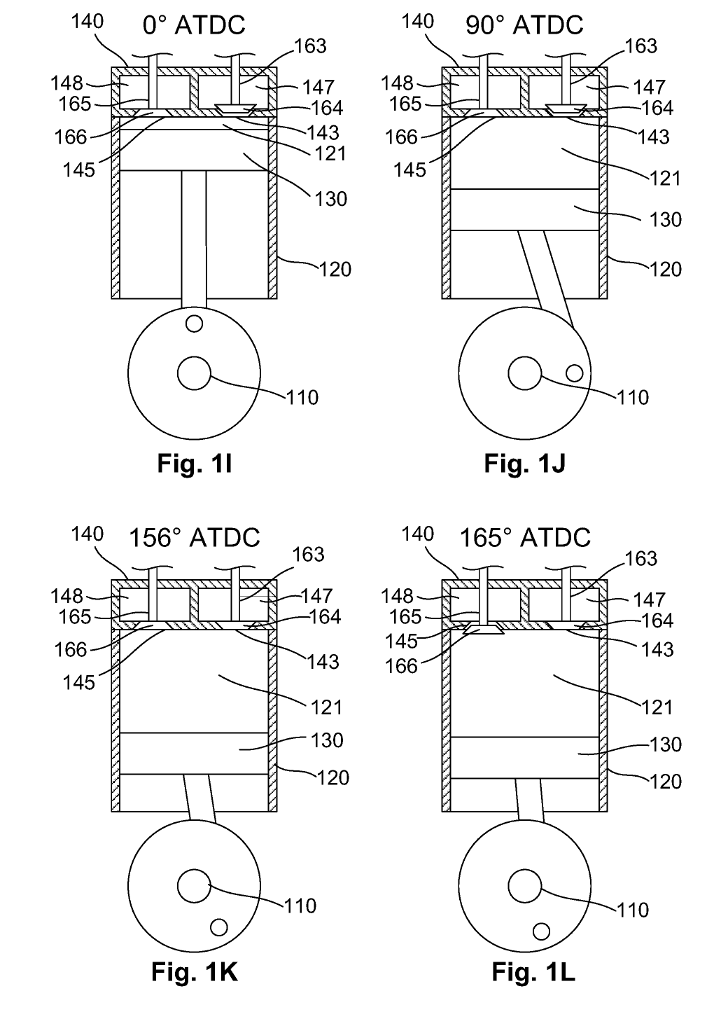

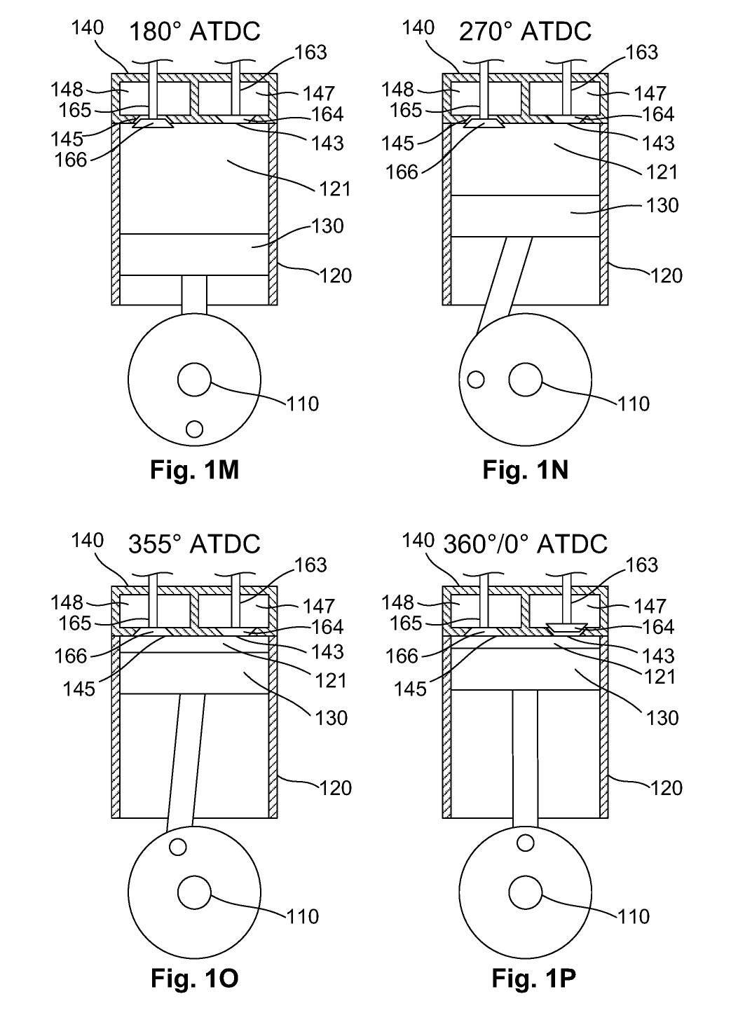

An example of a reciprocating engine 100 will now be described with reference to FIGS. 1A to 1D. As will become apparent from the description below, the engine 100 includes some features which are typically used in conventional reciprocating engine designs and it should be appreciated that such features may be provided in accordance with known techniques.

With reference to FIGS. 1A and 1B, the engine 100 typically includes a crankshaft 110, a cylinder 120 and a piston 130 which may be of generally conventional construction. As per conventional reciprocating engine arrangements, the cylinder 120 defines an internal chamber 121, with the piston 130 being positioned inside the chamber 121, the piston 130 being connected to the crankshaft 110 and being configured to reciprocate inside the chamber 121.

In this case the engine 100 has a single cylinder 120 and piston 130, although it will be appreciated that engine configurations having multiple cylinders 120 and corresponding pistons 130 may be used, in accordance with known techniques. In multiple-cylinder engine configurations, each piston 130 may be connected to a common crankshaft 110 (although this is not essential), and the cylinders 120 may be arranged in a variety of geometries such as those found in typical inline, V, radial and flat engine configurations.

In any case, the engine 100 further includes a head 140 attached to the cylinder 120 and closing the chamber 121 at an end opposing the piston 130. It should be noted that multiple-cylinder engine configurations as mentioned above may include multiple heads 140 corresponding to each cylinder 120, or alternatively, may include one or more heads 140 common to more than one cylinder 120.

Further details of the underside of the head 140 which interfaces with the chamber 121 are shown in FIG. 1C. The head 140 includes port groups 141, 142 including two or more ports 143, 145 for allowing fluid communication between the chamber 121 and a respective manifold (not shown) connected to an opening 144, 146 formed in the head 140.

In this case, the head 140 includes two port groups 141, 142. In particular, an inlet port group 141 is provided for allowing fluid to be communicated between the chamber 121 and an inlet manifold (not shown) connected to an inlet opening 144 via two inlet ports 143, and an exhaust port group 142 is provided for allowing fluid to be communicated between the chamber 121 and an exhaust manifold (not shown) connected to an exhaust opening 146 via two exhaust ports 145.

It will be appreciated that the fluid to be communicated via each of the port groups 141, 142 will depend on the type of reciprocating engine 100. In an internal combustion engine, the inlet manifold may supply a fuel/air mixture which is communicated into the chamber 121 via the inlet port group 141 to be combusted, and products of the combustion may be communicated from the chamber 121 into the exhaust manifold via the exhaust port group 142. Alternatively, in an air engine, pressurised air may be supplied by the inlet manifold and communicated into the chamber 121 via the inlet port group 141 to be expanded, and expanded air may be communicated from the chamber 121 into the exhaust manifold via the exhaust port group 142.

For the purpose of this example, it will be assumed that the engine 100 is configured to operate as an air engine, although it will be appreciated that features of the engine 100 may be applied to any suitable reciprocating engine type. It is also noted that this example will assume a two-stroke reciprocating engine cycle although it will be understood that similar principles may be adapted for use with four-stroke cycles or other engine cycles.

In any case, the engine 100 further includes, for each port group 141, 142, a valve arrangement 161, 162 (generally indicated in the top view of FIG. 1D), coupled to the head 140. Each valve arrangement 161, 162 includes, for each port 143, 145 a valve 163, 165 for operatively controlling fluid flow through the respective port 143, 145.

Thus, in this example, an inlet valve arrangement 161 is provided which includes inlet valves 163 for controlling fluid flow through the inlet ports 143 of the inlet port group 141, and similarly, an outlet valve arrangement 162 is provided which includes exhaust valves 165 for controlling fluid flow through the exhaust ports 145 of the exhaust port group 142. There are two valves 163, 165 in each valve arrangement 161, 162 in this example, although it should be understood that more than two valves 163, 165 may be provided in a valve arrangement 161, 162, with the number of valves 163, 165 corresponding to the number of ports 143, 145 in the respective port group 141, 142.

Each valve arrangement 161, 162 includes a bridge 171, 172 coupled to the valves 163, 165. In this example, an inlet bridge 171 is coupled to the two inlet valves 163 and an exhaust bridge 172 is coupled to the two exhaust valves 165. The bridges 171, 172 are configured such that movement of each bridge 171, 172 relative to the head 140 causes synchronised operation of the respective valves 163, 165 coupled thereto.

Each valve arrangement 161, 162 also includes an actuator 181, 182 for causing the respective bridge 171, 172 to move based on the reciprocation of the piston 130. Thus, each bridge 171, 172 is able to move such that the valves 163, 165 can control fluid flow through the respective ports 143, 145 in time with the operation of the engine 100.

The operation of the actuators 181, 182 may be controlled based on the reciprocation of the piston 130 in a range of different ways. For example, the actuators 181, 182 may be mechanically coupled to the crankshaft 110 such that the actuators 181, 182 cause the respective bridges 171, 172 to move depending on the rotational position of the crankshaft 110, as it will be understood that this will correspond to the reciprocation of the connected piston 130. The actuators 181, 182 may be provided in the form of cams on a cam shaft which is rotationally coupled to the crankshaft 110, such as by using a timing belt or timing chain connection. Each cam may engage with the respective bridge 171, 172 to cause the bridge to move in a particular manner depending on a profile of the cam. Further details of such an arrangement using cams as actuators 181, 182 will be provided in a later example.

Alternatively, a sensor (not shown) may be provided for sensing a position of the piston 130 or the rotational position of the crankshaft, and the actuators 181, 182 may be operated based on signals provided by the sensor. In this case the actuators 181, 182 may be electro-mechanically actuated as required depending on the sensed position and this may allow more highly controlled or complex movement of the bridges 171, 172 than might be allowed under a mechanically coupled arrangement.

In any event, each of the bridges 171, 172 is coupled to valves 163, 165 which control fluid flow through the ports 143, 145 of a respective port group 141, 142, and thus allows for synchronised control of fluid flow into or out of the chamber 121 via each port group 141. This allows an engine 100 to be provided with multiple inlet ports 143 and/or outlet ports 145 arranged in a group and controlled together in synchronisation. However, whilst a port group 141, 142 is provided for each of the inlet ports 143 and outlet ports 145 in this example, this is not essential and it may be the case that separate conventionally valved inlet or outlet port arrangements may be used together with a port group 141, 142 as per the above example.

It will be appreciated that the above reciprocating engine 100 arrangement provides an effective technique for controlling a plurality of ports 143, 145 simultaneously using a relatively straightforward mechanical arrangement. The use of groups of multiple inlet and exhaust ports 143, 145 controlled by corresponding valves 163, 165 for controlling gas flow therethrough is generally beneficial compared to the use of single inlet and exhaust ports, because it provides for greater gas flow rates without the need to increase the size of the valves 163, 165, thus helping to ensure responsiveness and energy efficiency. However, in conventional engines, the control of multiple valves has led to significantly increased complexity.

In contrast, the arrangement discussed above allows multiple valves 163, 165 corresponding to a port group 141, 142 to be simultaneously controlled in a reliable manner using the bridges 171, 172, with a significant reduction in complexity compared to conventional valve control techniques. This arrangement can also lead to substantial improvements in the responsiveness of the valves 163, 165 which may contribute to improved efficiency.

In the present example where the engine 100 is configured to operate as an air engine, the inlet bridge 171 will generally be moved by the corresponding actuator 181 such that the inlet valves 163 permit pressurised air to be supplied into the chamber 121 via the inlet ports 143 as the piston 130 moves from a position at or near top dead centre into a downward stroke (i.e. in a direction away from the head 140), so that the pressurised air can drive the piston 130 and cause power to be delivered to the crankshaft 110.

As will be appreciated from a comparison of FIGS. 1A and 1B, each of these Figures shows the engine 100 with a different piston position. In particular, FIG. 1A shows the engine 100 shortly after the piston 130 has started a downward stroke after passing top dead centre, and in which the actuators 181, 182 have caused the inlet and exhaust bridges 171, 172 to move upwardly into a raised position. On the other hand, FIG. 1B shows the engine 100 shortly after the piston 130 has started an upward stroke after passing bottom dead centre (180° after top dead centre), and in this case the actuators 181, 182 have caused the inlet and exhaust bridges 171, 172 to move downwardly into a lowered position.

It will be understood that, in the context of an air motor, FIG. 1A illustrates a snapshot during a power stroke, in which the piston 130 is driven by pressurised gas to do work. FIGS. 1E and 1F respectively show cross section views through the inlet valve assembly 161 and exhaust valve assembly 162 as indicated in FIG. 1D.

With reference to FIG. 1E, the raised position of the inlet bridge 171 causes the inlet valves 163 to be lifted open such that inlet valve seals 164 are disengaged from the inlet ports 143. This allows pressurised air, which is supplied into an inlet chamber 147 through the inlet opening 144 as indicated by arrow 101, to pass through the inlet ports 143 into the chamber 121. Thus pressurised gas is able to act upon the piston 130 to drive the power stroke of the engine 100.

Turning to FIG. 1F, which shows the exhaust assembly 162 components at the same piston 130 position as FIG. 1E, it will be appreciated that the raised position of the exhaust bridge causes valve seals 166 of the exhaust valves 165 to be engaged with the exhaust ports 145 such that the exhaust ports are closed to prevent the escape of pressurised gas from the chamber 121.

FIG. 1B illustrates a snapshot during a return stroke, in which the piston 130 expels expanded gas from the chamber 121. FIGS. 1G and 1H provide corresponding cross section views through the inlet valve assembly 161 and exhaust valve assembly 162.

With regard to FIG. 1G, the inlet actuator 181 has caused the inlet bridge 171 to move into the lowered position and this has in turn lowered the inlet valves 163 so that the inlet valve seals 164 close the inlet ports 143 and prevent pressurised gas from entering the chamber 121 during the return stroke.

In FIG. 1H, the lowered position of the exhaust bridge 172 causes the exhaust valve seals 166 of the exhaust valves 165 to be disengaged from the exhaust ports 145 in a downward direction so as to open the exhaust ports 145 and allow exhaust gas to be expelled via the exhaust ports to the exhaust chamber 148 and in turn out of the head 140 through the exhaust opening 146 as indicated by arrow 102.

The bridges 171, 172 can allow for the mechanical complexity of the engine 100 to be significantly reduced compared to conventional engines with multiple inlet and/or outlet valves per cylinder. For instance, the use of a bridge 171, 172 for each port group 141, 142 means that a suitable actuator 181, 182 only needs to be provided for the control of each port group 141, 142, as opposed to separate actuators (cams, rocker arms, etc.) for each valve as per conventional designs. This can reduce the number of moving parts and potential points of wear and/or failure in the design of the engine 100.

Following from the above mentioned reduction in mechanical complexity, the moving mass of the valve arrangements 161, 162 may be reduced compared to the equivalent moving mass of equivalent conventional valves and actuators and this may allow for improved responsiveness in the control of the ports 143, 144, 145, 146. In other words, the bridges 171, 172 can facilitate improved speed and effectiveness in switching fluid flow into or out of the chamber. This may in turn allow the engine 100 to operate at higher rotational speeds and/or allow the ports 143, 145 to be controlled under timing parameters that are not available using conventional arrangements. It will be appreciated that this may allow the engine 100 to have higher performance and/or efficiency than may otherwise be available for an equivalent engine of conventional design.

In the case of mechanically coupled actuators 181, 182, the reduced mechanical complexity of the valve arrangements 161, 162 compared to conventional valve systems may also lead to reduced loading on the engine 100 to operate the valves 163, 165, thus allowing the engine 100 to have further increased efficiency in comparison to conventional designs.

It will be appreciated that the particular movements of the bridges 171, 172, caused by the actuators 181, 182, may be selected depending on a range of factors such as the type of the valves 163, 165 coupled to the bridge 171, 172, fluid flow requirements, and the like. As exemplified above, raising the bridges 171, 172 may result in positively opening or closing the associated valves 163, 165 depending on whether these are configured to open by moving into the head 140 as per the inlet valves 163 or into the chamber 121 as per the exhaust valves 165. Alternatively, the actuators 181, 182 may cause one or both of the bridges 171, 172 to be lowered toward the head 140, to positively open or close the valves 163, 165. In some examples, the actuators 181, 182 may be configured to positively raise and lower the bridges 171, 172 so as to positively open and close the valves 163, 165.

Accordingly, it will be appreciated that the configuration of the valves 163, 165 and their particular opening and closing behaviour depending on the movements of the bridges 171, 172 caused by the actuators 181, 182 are not particularly limited, although, as will become apparent in later examples, certain arrangements may be advantageous in particular applications.

The above described arrangement may also allow the use of valves 163, 165 having unconventional designs and principles of operation. For instance, the bridges 171 allow the valves 163, 165 to be opened and closed by pushing or pulling actions, depending on how the actuators 181, 182 and the valves 163, 165 are configured. This allows greater flexibility in how the valves 163, 165 may be used to control fluid flow through the ports 143, 145, compared to conventional modern valved engines which typically use standard poppet valve arrangements.

For example, at least some of the valves 163, 165 may be configured such that they are pulled open into the head 140 to thereby avoid intrusion of part of the valves 163, 165 into the chamber 121. This represents an effectively inverted operation compared to standard poppet valves, which are typically pushed open such that a sealing plug intrudes into the chamber, requiring careful design to avoid interference with the piston in use. Such inverted operation may allow further efficiency improvements through the minimisation of dead volume in the cylinder which may otherwise be required in conventional engines to avoid interference with valves. Furthermore, the ability to invert the operation of the valves 163, 165 in this manner can allow the design to take better advantage of pressure differentials throughout the operation of the engine 100 to assist in the opening or closing of the valves 163, 165.

In this case, the inlet valves 163 have an inverted operation as discussed above, whilst the exhaust valves 165 have an opening operation similar to conventional internal combustion engine valves.

The use of the bridges 171, 172 as discussed above may also allow the valves 163, 165 to be positively driven into opened and closed positions, thus removing valve float effects which are otherwise encountered at high speed operation of conventional engines using poppet valves, which are traditionally only actively opened by a cam but closed by a spring.

It will be appreciated that the particular opening and closing timing of the valves 163, 165 for controlling fluid flow for each port group 141, 142 may be selected to tune the performance of the engine 100 as desired. Particular examples of timing suitable for operation of the engine 100 as an air engine are provided in FIGS. 1I to 1P, which show cross section views perpendicular to those shown in FIGS. 1E to 1H so as to show the positions of the inlet and exhaust valves 163, 165 relative to piston positions measured with respect to the top dead centre position.

FIG. 1I shows the inlet valves 163 opening at 0° after top dead centre (ATDC), thus commencing the power stroke by allowing pressurised air supplied into the inlet chamber to pass into the chamber 121 via the inlet ports 143. This configuration is allowed to continue through 90° after top dead centre as shown in FIG. 1J, until approximately 156° after top dead centre where the inlet valves 163 are closed as shown in FIG. 1K. Shortly thereafter, the exhaust valves 165 are opened as indicated in FIG. 1L which shows 165° after top dead centre. The exhaust valves 165 are only opened after the inlet valves 163 are closed to prevent cross-bleed and thus wastage of pressurised air.

As shown in FIG. 1M, the piston 130 moves through 180° after top dead centre (or bottom dead centre) with the exhaust valves 165 remaining open and following this the return stroke commences, throughout which the now expanded gas in the chamber 121 is expelled via the exhaust ports 145. FIG. 1N shows the continued return stroke through 270° after top dead centre. At 355° after top dead centre, as shown in FIG. 1O, the exhaust valves 165 are closed in preparation for the next power stroke. The piston 130 is finally returned to a top dead centre position as shown at FIG. 1P, where the inlet valves 163 are once again opened and the next cycle of the engine 100 commences.

It will be appreciated that the engine 100 may be constructed using known engine manufacturing techniques and conventional materials. In one example, the cylinder 120 and chamber 121 may be formed as part of a crankcase 101 which encloses the crankshaft 110. Engine components/assemblies such as the crankcase 101, cylinder 120, piston 130, connecting rod 131, head 140, parts of the valve assemblies 161, 162, and the like may be manufactured from any suitable materials including steel, aluminium alloys, ceramics, plastics or the like, depending on operational requirements.

Further details of preferred construction techniques and examples of optional features will now be described with reference to the following detailed examples of embodiments of the engine.

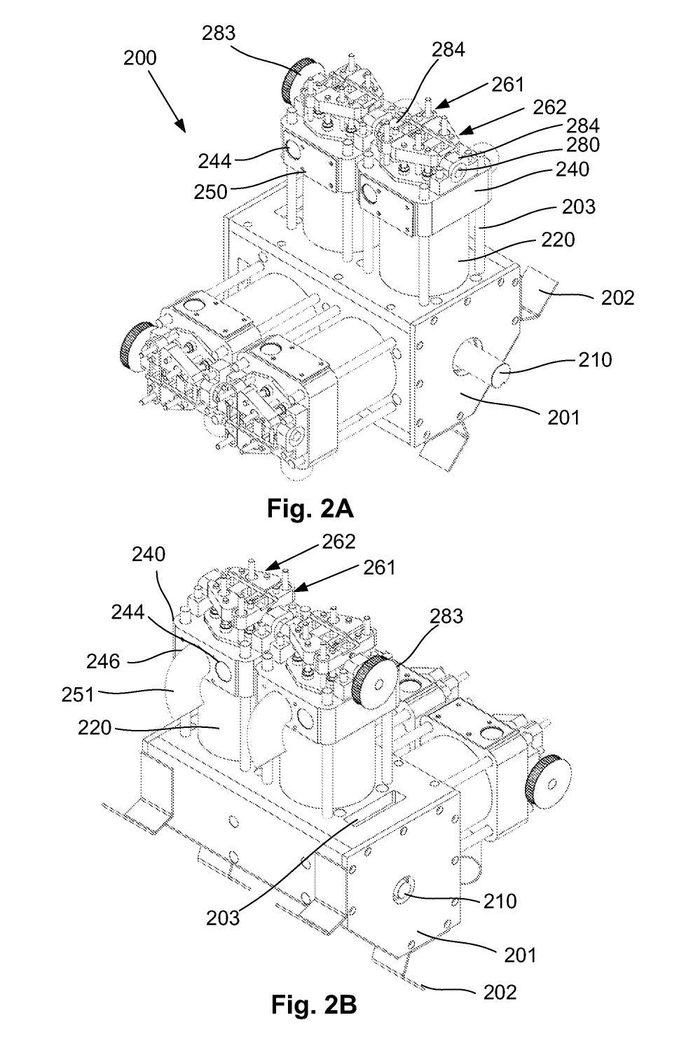

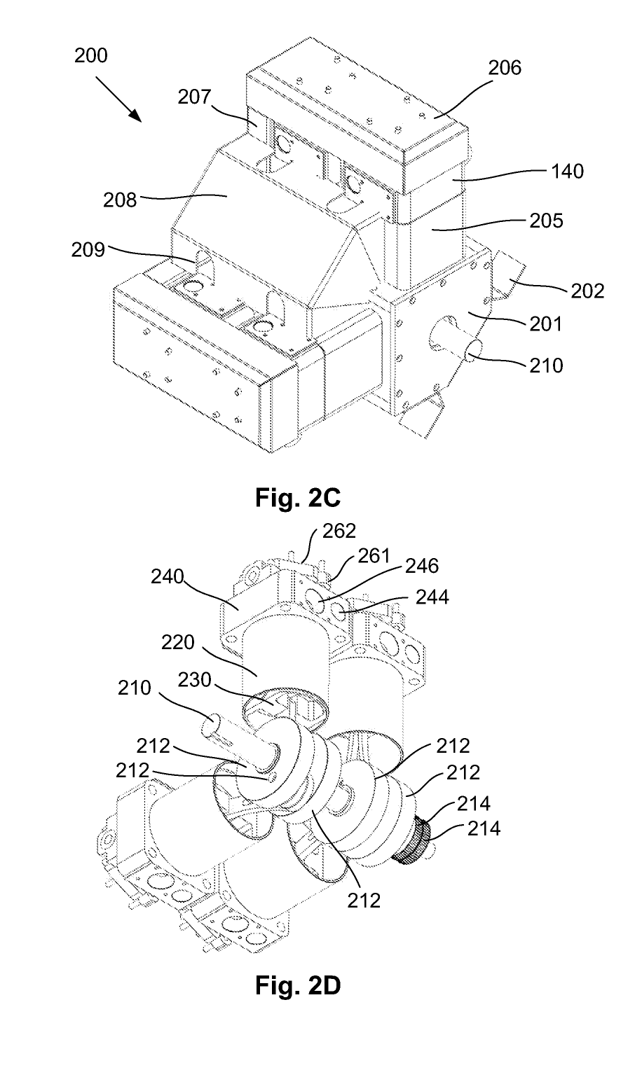

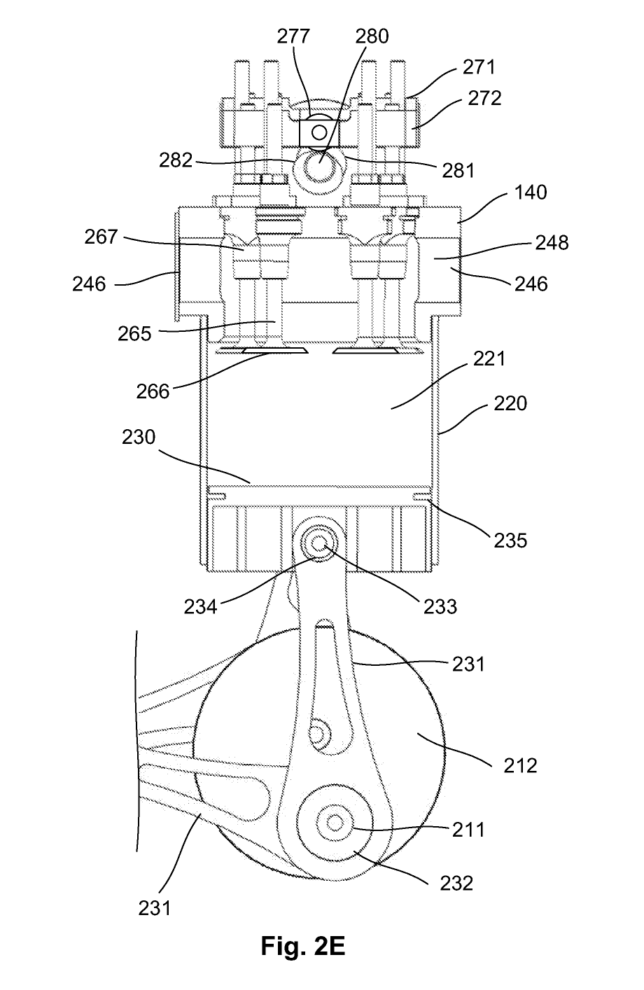

An example of an air engine 200 embodying features of the reciprocating engine 100 discussed above will now be described with reference to FIGS. 2A to 2E. Components similar to those discussed in the previous example have been assigned similar reference numerals, incremented by 100 from those used previously.

With reference to FIGS. 2A and 2B, it can be seen that the air engine 200 includes a central crankcase 201 to which four cylinders 220 are attached. In this example the crank case 201 is formed from machined plates of aluminium fastened together using suitable fasteners, such as screws. However it will be appreciated that a range of different crank case construction techniques may be used subject to particular design requirements for the air engine 200. Engine mounts 202 may be fitted to the crankcase 201 for installation purposes.

The crankcase 201 houses a crankshaft 210 which is typically supported by bearings (not shown) attached to the crank case 201 structure. Roller bearings are preferred to ensure good support with reduced friction, although it will be appreciated that other types of bearings such as ball bearings or journal bearings may be used.

The four cylinders 220 of the air engine 200 extend from the crank case 201 in two banks. In this example, the air engine 200 has a V4 configuration. In other words, the four cylinders of the air engine 200 includes four cylinders 220 and corresponding pistons 230 positioned within are arranged about the crankshaft 210 in a “V” shape. In this case, respective banks of cylinders 220 on either leg of the “V” are offset to one another by an angle of 90°.

The cylinders 220 may be formed from aluminium or any other material suitable for withstanding the operating conditions within the chamber in use.

FIG. 2D shows a further view of the air engine 200 with the crank case 201 removed to expose details of the crankshaft 210 and pistons 230. A piston 230 is provided inside each cylinder 220 and is attached to the crankshaft 210 using a connecting rod 131.

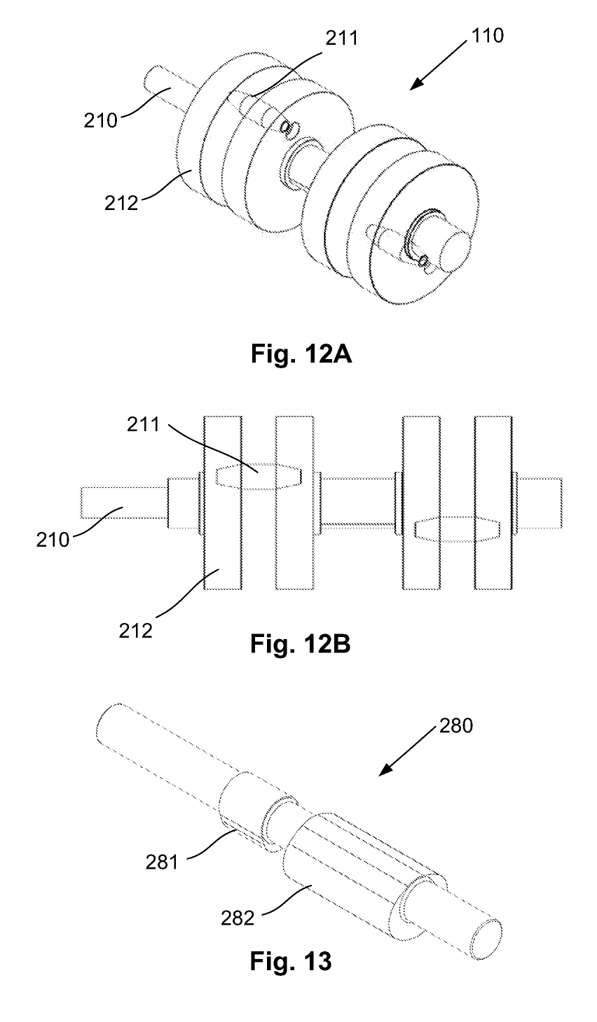

The crankshaft 210 includes two crank pins 211 which each extend between two webs 212 and are offset from a rotation axis of the crankshaft 210. Further details of the crankshaft 210 can be seen in FIGS. 12A and 12B.

The crank pins 211 are each coupled to two connecting rods 231, which are in turn coupled to a respective piston 230 in each leg of the “V” formed by the banks of cylinders 220. The crank pins 211 are each offset from each other by 180°, which in view of the 90° angle between the banks of cylinders 220 provides a 90° angular offset between each of the four pistons 230 with respect to the rotational position of the crankshaft 210. This has the effect of staggering the positions of the pistons 230 within their respective cylinders 220 to allow even delivery of power by the air engine 200, and with appropriate valve timing, overlapping of power strokes to allow the air engine 200 to be self-started without requiring a starter motor or the like.

Further details of the interrelationship between a cylinder 220, piston 230 and head 240 can be seen in the cross section view of FIG. 2E. The visible piston 230 can be seen to be connected to the crank pin 211 by the connecting rod 231. Typically a bearing 232 is provided at the connection between one end of the connecting rod 231 and the crank pin 211. A gudgeon pin 233 is used to connect the piston 230 to the other end of the connecting rod 231, and another bearing 234 may also be provided at this connection.

In this example the pistons 230 are formed from an engineering plastic material, such as acetyl. However, it will be appreciated that any suitable material may be used. The use of a relatively lightweight material coupled with the formation of appropriate lightening features in the design of the piston 230 helps to reduce the weight of the pistons 230 and thus energy required to move the pistons 230 during operation of the air engine 200. In the present example the pistons 230 are fitted with pneumatic seals (not shown) positioned within seal guides 235. Alternatively other types of seals such as guide ring seals may be used. In any event this may allow operation of the air engine 200 without requiring a lubrication system. Nevertheless, it will be appreciated that conventional lubricated piston arrangements may be used. The pistons 230 may include concave piston faces which may provide desirable pressurised gas flow and pressure application characteristics in use.

A respective head 240 is fitted to each cylinder 220 and each head 240 includes a respective inlet valve arrangement 261 and an exhaust valve arrangement 262 as generally indicated in FIGS. 2A and 2B, and which operate as discussed above with regard to the previous example.

The head 240 may have a standardised design such that the same head 240 component can be fitted to each cylinder 220 irrespective of its position on the air engine 200. It will be appreciated that the use of a common head 240 design on each cylinder 220 can be desirable as this will help to reduce the unique parts count required to construct air engine.

The head 240 may include a respective inlet opening 244 and exhaust opening 246 on two sides to facilitate flexible positioning. For instance, on heads 240 fitted on cylinders on one of the cylinder banks, an inlet manifold and an exhaust manifold may be respectively connected to the inlet opening 253 and exhaust opening 254 on one side of the head 240 and a cover plate 250 may be attached to the other side of the head 240 to cover at least one of the openings 244, 246 on that side. The use of the openings 244, 246 of the heads 240 on the other cylinder bank may be reversed by having the manifolds connected to the openings 253, 254 on a different side of the head 240. In the present example the cover plate 250 leaves the inlet opening 244 open so that pressurised air can be supplied to the head 240 from each side, but closes the exhaust opening 146 so that exhaust air only exits the head 240 on one side, via exhaust manifold piping 251 as partially shown in FIG. 2B.

The head 240 may accommodate different valve arrangement 261, 262 configurations to allow different valve timing characteristics. Each head 240 may be made from machined aluminium although it will be appreciated that different materials may be used.

Whilst the head 240 shown in this example is formed from a single part, it will be understood that it will be possible to construct the head 240 from multiple parts. This may allow complex internal porting geometries that cannot be readily machined into a single part. Multiple parts of the head 240 may be fastened together mechanically using any suitable fastening technique. A gasket may be located between head 240 parts to ensure good sealing of porting that may be defined through the parts.

It will also be appreciated that, whilst the present example includes discrete components for providing the cylinder 220 and the head 240, in some embodiments the cylinder 220 and head 240 may be formed integrally as a single part, which may be formed using casting and/or machining processes.

Whilst this example provides a separate head 240 for each cylinder 220, it will be appreciated that a bank of multiple cylinders 220 may be fitted with a single component which integrates multiple effective heads 240 each having features as described above. Although this may remove the commonality advantages of using standardised heads 240 on each cylinder 220, this may allow for further weight reductions and may be useful in high-volume production of engines 200.

The cross section view of FIG. 2E reveals details of the exhaust valves 265, positioned in exhaust porting formed within the head 240. Each of the valves 263, 265 is supported inside the head 240 using a valve guide 267. The valve guides 267 provide a stable lateral support for the valves 263, 265 so that they are positioned accurately with respect to the ports 243, 245, whilst allowing smooth axial opening and closing operations.

In this example, the valve guides 267 are removable and have identical construction irrespective of whether these are used to support inlet valves 263 or exhaust valves 265.

In FIG. 2E, it can also be seen that the inlet and exhaust bridges 271, 272 are moved by inlet and exhaust cams 281, 282 which serve as the respective actuators for moving the bridges 271, 272. In particular, the cams 281, 282 engage with one or more cam followers 277 coupled to the bridges 271, 272 and rotate on a camshaft 280 based on the rotational position of the corresponding piston 230. Each cam follower 277 may be provided in the form of a cylindrical roller supported on a shaft attached to the respective bridge 271, 272. Further details of the operation of the valve arrangements 261, 262 will be provided in due course.

Further details of the camshaft 280 and mounted cams 281, 282 can be seen in FIG. 13. In this example, the inlet cam 281 has a lobe design which provides approximately 156° of inlet valve 263 opening by lifting the inlet bridge 271. It will be appreciated that extends for most of the piston's power stroke and is an exceptionally long time of exposure of pressurised gas to the piston 130 compared to conventional air engine designs. The exhaust cam 282 has a lobe design which provides 170° of exhaust valve 265 closure by lifting the exhaust bridge 272. The inlet cam 281 and exhaust cam 282 have their lobes protruding generally on the same side of the camshaft which results in the exhaust valves 265 being closed whilst the inlet valves 263 are open, to avoid the escape of pressurised gas during power strokes.

FIG. 2C shows the air engine 200 with a number of covers attached. These covers may be used to protect internal components of the air engine 200 from the external environment and/or protect operators from coming into contact with internal components.

Cylinder covers 205 may be provided to enclose the actual cylinders 220 so as to provide desirable thermal characteristics and/or a protective barrier about the cylinder 220 and piston 230 positioned inside. Head covers 206 may be provided to enclose working components of the inlet and exhaust valve arrangements 261, 262 and thus help to mitigate hazards which may arise due to inadvertent contact with moving parts and/or reduce the risk of parts from being thrown from the air engine 200 in the event of a mechanical failure. A timing pulley cover 207 may also be provided to prevent pinch hazards or prevent a timing belt used to couple the crankshaft 210 to the camshafts 280 from being thrown in the event of failure.

A valley cover 208 may be provided spanning between the banks of cylinders 220 and may protect manifold tubing (not shown) for supplying compressed air to inlet openings 244 or removing exhaust air from exhaust openings 246 of the heads 240. In this case the valley cover includes cutouts 209 through which inlet manifold tubing may be routed from the inlet openings 244.

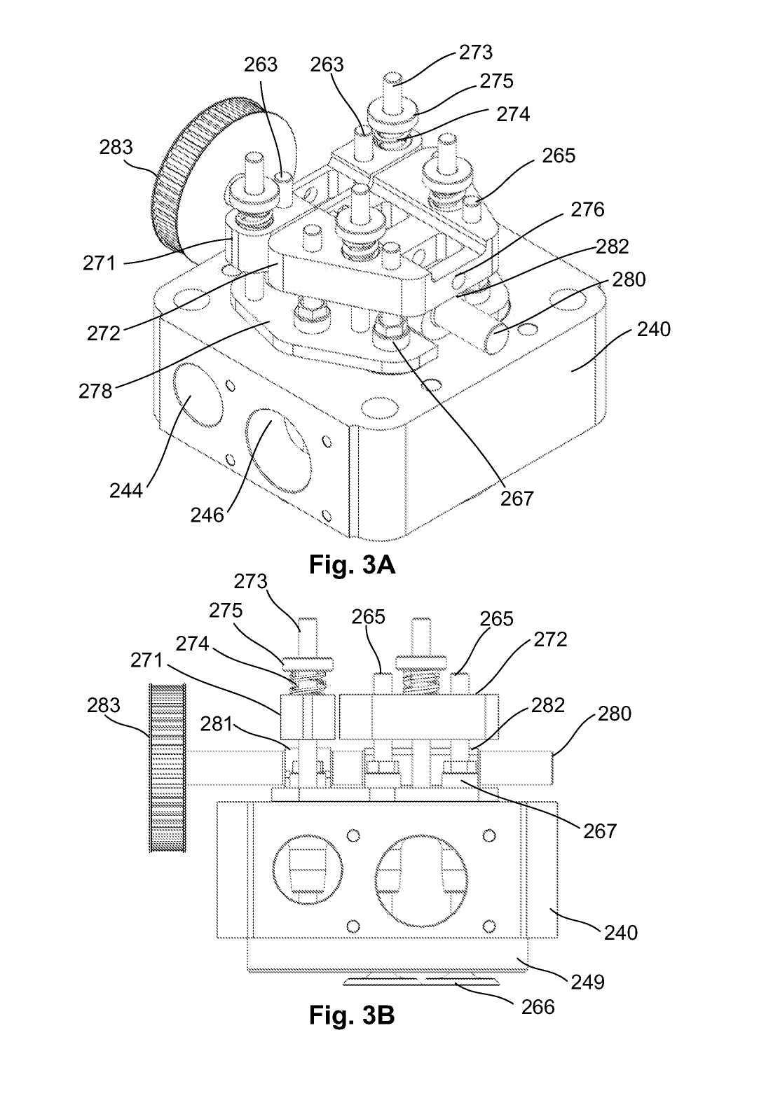

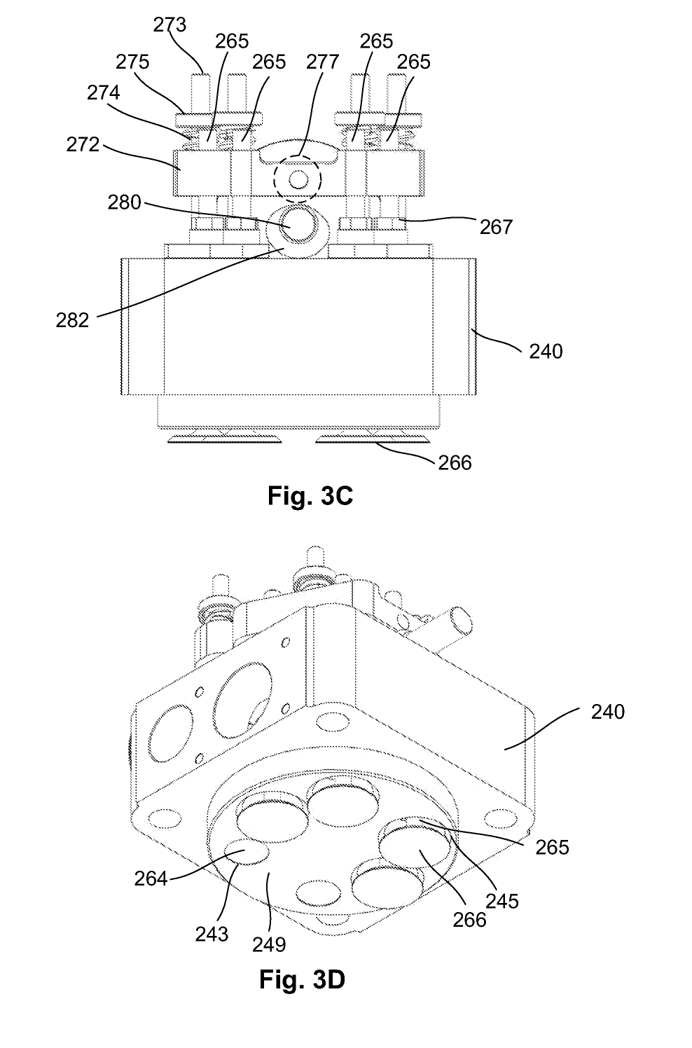

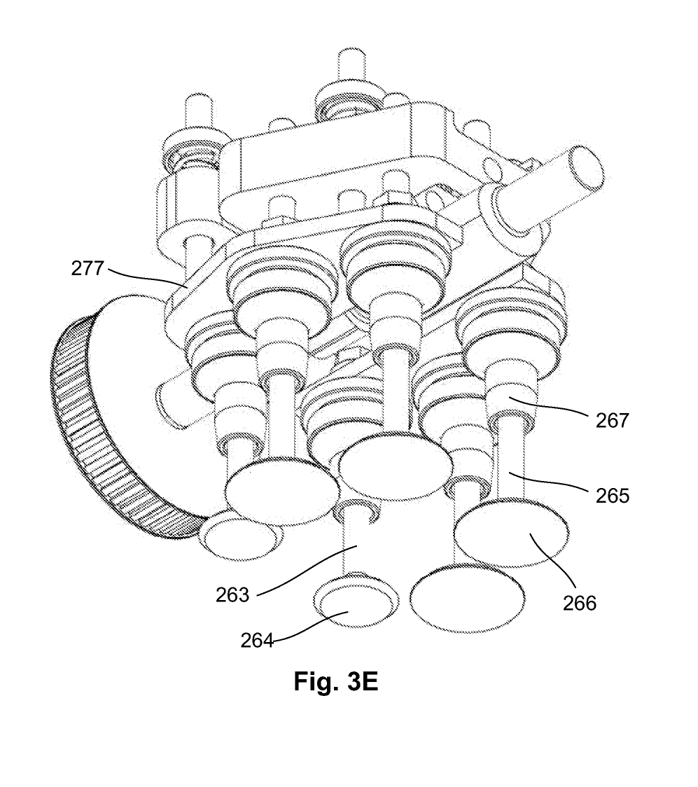

FIGS. 3A to 3D show different views of an isolated head 140 and corresponding valve assemblies 261, 262 of the air engine 200.

The inlet valve assembly 261 includes two inlet valves 263 coupled to an inlet bridge 271, whilst the exhaust valve assembly 262 includes four exhaust valves 265 coupled to a single exhaust bridge 272, thus exemplifying a case having a valve group including more than two valves 265. Each valve 263, 265 is supported in the head 240 by a valve guide 267 which is fixed in position relative to the head 240, using a shouldered, threaded locating system, by which stud plates 278 are then attached to the valve guides 267. The valves 263, 265 slidingly move through apertures formed longitudinally through the valve guides 267, such that only linear motion of the valves 263, 265 will be allowed, depending on the movement of the bridges 271, 272. However, it will be appreciated that such linear motion of the valves 263, 265, whilst desirable, is not essential and alternative arrangements may be provided to allow non-linear motion of the valves 263, 265.

Each bridge 271, 272 is supported by studs 273 which extend outwardly from the stud plates 278 coupled to an upper face of the head 240. The bridges 271, 272 are coupled to the studs 273 so that the bridges 271, 272 can move in a direction aligned with longitudinal axes of the studs 273, and in this case this movement direction also aligns with the reciprocation direction of the respective piston 230. Each stud 273 includes a retainer 275 for a biasing member for biasing the bridges 271, 272 towards the head 240. In this example, springs 274 are provided on each stud 273, and these springs 274 serve as the biasing members. It will be appreciated, however, that in some examples, a biasing member may not even be required, such as where the bridge 271, 272 is moved by an actuator in both directions for opening and closing the respective valves 263, 265. Nevertheless, springs 274 may still be provided for cushioning the closure operation and helping to reduce wear.

Movements of each bridge 271, 272 are caused by cams 281, 282 mounted on a camshaft 280. A camshaft timing pulley 283 is mounted at one end of the camshaft 280 and a timing belt (not shown) connects the camshaft timing pulley 283 to a crankshaft timing pulley 214 mounted at an end of the crankshaft 210. With regard to FIG. 2B, it will be seen that the crankcase 201 includes a slot 203 for allowing the timing belt (not shown) to extend between the camshaft timing pulley 283 and one of the crankshaft timing pulley 214 located inside the crankcase 201.

In this example, the respective pulleys 283, 214 have matching dimensions and numbers of gear teeth so as to provide a 1:1 timing relationship, in which one complete revolution of the crankshaft 210 causes one complete revolution of the camshaft 280. This provides a 2 stroke valve timing suitable for operation of the air engine 200. It will be appreciated that a 2:1 timing relationship may be used for 4 stroke timing, as may be desirable for an internal combustion engine.

As shown in FIG. 3C, the cams 281, 282 are profiled to periodically raise lift the respective bridges 271, 272 as the camshaft 280 rotates, and one or more cam followers 277 may be provided on the bridges 271 to allow smooth movement of the bridges 271, 272 based on the rotating cam profiles. It will be appreciated that the bridges 271, 272 will be lifted directly by the lobes formed in the cams 281, 282 into a raised position, whilst the action of the springs 274 will otherwise bias the bridges 271, 272 towards a lowered position and ensure engagement between the cams 281, 282 and respective cam followers.

The springs 274 provided for each bridge 271, 272 may have different spring stiffness depending on the desired operation of the respective bridge. For example, the springs 274 used with the inlet bridge 271 may have a relatively low spring stiffness because the inlet valves 263 are designed so that pressurised gas in the inlet chamber 247 will tend to retain the inlet valves 263 in the closed position until they are positively lifted open by the inlet bridge 271.

As discussed previously, the inverted operation of the inlet valves 263 may be more suitable for use in air engine embodiments. In the present example, opening of the inlet valves 263 is positively controlled through the upward movement of the inlet bridge 271 by the inlet actuator 281, and the inlet valves 263 are closed by springs. The springs 274 may have relatively light spring stiffnesses, since the pressurised gas can assist in maintaining the inlet valves 263 in a closed position.

The particular spring stiffness for the springs 274 of the inlet bridge 271 will be selected with regard to the surface area of the inlet valves 263 upon which the pressure load will be applied in the closed state, so that adequate closing force is applied as required, but to avoid the need for excess force to be applied to the inlet bridge 271 to open the inlet valves 263. This can help to ensure that the inlet valves 263 are highly responsive in use. In contrast, the springs 274 used with the exhaust bridge 272 need only be of a tension calculated to apply slightly greater force than the force exerted on the exhaust valve 265 faces inside the chamber 221 when the exhaust valves 265 are not being positively lifted into a closed position by the exhaust bridge 272.

In any event, suitable selection of the springs 274 for each bridge 271, 272 with consideration of the applied gas pressures during operation can help to ensure desirable speedy valve opening and closing performance. Furthermore, suitable spring 274 selection coupled with the particular design configuration of the valves 263, 265 and corresponding ports 243, 245 help to eliminate many traditional valve issues, such as valve bounce (wear), valve stretching, and can result in a cushioned closing effect for the exhaust valve 265, and reduce opening force requirements for the inlet valve 263.

In an alternative arrangement, the inlet valves 263 may have a similar configuration as the exhaust valves 265, such that they have a generally conventional poppet valve seal which moves downwardly into the chamber 221 (i.e. towards the piston 230) when opened and is closed by moving upwardly (i.e. away from the piston 230). The operation of inlet valves 263 configured in this manner would involve positively closing the inlet valves 263 when the inlet actuator 281 (i.e. a cam or the like) moves the inlet bridge 271 upwardly away from the head, as per the exhaust valves 265.

This positive closing action in the above mentioned alternative inlet valve 263 configuration would prevent unintentional opening of the inlet valves 263 due to the pressurised gas supply. The inlet valves 263 would be opened under the influence of a biasing member (i.e. a spring) in this case, and this opening action would be assisted by the supply of pressurised air. In some circumstances, the biasing member would not even be required and opening could be entirely effected by the pressurised air, although a spring may still be incorporated to provide a cushioning effect during closure and to assist the opening operation for improved responsiveness.

It is noted that despite the use of a generally conventional poppet valve seal design in the exhaust valves 265, and in the alternative inlet valve 263 configuration mentioned above, the particular opening and closing regime due to the use of the bridge 271 is still reversed compared to a poppet valve implementation in a conventional internal combustion engine, where the valve is positively opened and the valve closure relies on spring tension. Thus, the valve operation for the engine 200 is less dependent on springs than for conventional engines.

In any case, it is noted that the springs 274 may be located entirely outside the head and thus will not be exposed to air flow or temperature fluctuations during the use of the air engine 200. Furthermore the external arrangement of springs 274 in this example does not restrict air flow through the head 240.

It will be appreciated that the opening and closing motions of the valves 263, 265 in the air engine 200 may be aligned with the piston 230 reciprocating direction. Although not essential, this allows for a mechanically simplified arrangement compared to many conventional engine designs which have valves which act at substantial angles with respect to the reciprocation of the piston. For instance, the inlet and exhaust bridges 271, 272 which control the operation of all of the valves 263, 265 can be moved using cams 281, 282 provided on the same camshaft 280. In contrast, conventional angled valve arrangements will usually require a separate camshaft for valves on either side of a cylinder, with separate cams for each valve. It will be appreciated, however, that separate camshafts may still be used to actuate each bridge 271, 272 in alternative embodiments of the engine.

Furthermore, the linear actuation of valves 263, 265 in relation to both the piston 230 face, and in relation to the bridges 271, 272 and respective actuators 281, 282 helps to provide improved energy efficiency by applying direct force (as opposed to angular force), and can also provide improved wear characteristics.

Turning back to FIG. 2A, it will be seen that the camshaft 280 may be supported by camshaft bearings 284 mounted on the head 240. The camshaft bearings 284 may be configured to allow adjustment of the relative positioning of the camshaft 280 above the head 240 so as to allow for cam 281, 282 designs with different sized lobes, which will in turn cause different opening behaviour for the valves 263, 265. In this example, a single camshaft 280 is used for two cylinders 220 across a cylinder bank of the air engine 200. This allows a single timing pulley 283 to be used for each cylinder bank. However, it will be appreciated that separate camshafts may be provided for each cylinder.

Valve timing can be adjusted with regard to advancing and retarding the valve 263, 265 opening and closing timing by rotating the camshaft 280 relative to the crankshaft 210 position. It may also be possible to operate the air engine 200 in a reverse direction by rotating the camshaft 280 by 180° relative to the crankshaft 210.

FIG. 3D shows further details of the underside of the head 240, which interfaces with the cylinder 220. A cylinder cap 249 is provided for engaging with the cylinder 220 to close the chamber 221. The ports 243, 245 are formed within the cylinder cap 249. It will be appreciated that the two inlet ports 243 in this case are of a significantly smaller diameter compared to the four exhaust ports 245.

These differences in diameter and in the number of ports for the inlet port group 241 compared to the exhaust port group 242 allow a significantly greater volumetric flow rate of exhaust gas to be removed from the chamber 121 compared to pressurised gas that can enter the chamber 121. It will be understood that this can account for the expansion of the pressurised gas during the power strokes of the air engine 200, such that the total mass of gas entering and exiting the chamber 121 will be approximately equal. Thus, performance efficiencies may be gained by exhausting through larger volume exhaust ports 245 or more exhaust ports 245 compared to the inlet ports 243.

FIG. 3E shows a similar view as for FIG. 3D but with the head 240 hidden to reveal further details of the valve supports 267 and valves 263, 265.

It is noted that the overall design of the head 240, valves 263, 265 and their respective bridges 271, 272 can enable minimal requirements for movements of the valves 263, 265 to achieve maximum opening or closing operations. As such this can permit the use of cams 281, 282 having cam lobes of less aggressive designs, which can provide benefits of smoother operation and reduced wear.

Construction features of the head 240 can be seen in further detail in FIGS. 6A to 6C. In this example, the head 240 is manufactured from a solid block of aluminium by drilling and other machining processes. The inlet openings 244 and inlet chamber 248 defined therebetween can be formed by drilling a hole across the width of the head 240, and the exhaust openings 246 and exhaust chamber 249 may be formed in a similar manner.

Guide apertures 601 may be drilled from an upper surface of the head 240 and exhaust apertures 604 can be formed by continuing the drilling through the depth of the head 240 to form the exhaust ports 245. On the underside of the head 240 a shoulder of the exhaust port 245 may be machined to form an exhaust valve seat 605. For the inlet ports 243, the inlet apertures 604 will not extend all the way through the head 240 at the same diameter but will stop short of the underside of the head, leaving an annulus of material to form inlet valve seats 603 to allow sealing of the inlet valves 263.

Whilst this example shows a head 240 of single part construction, it will be appreciated that more complex internal geometries may be formed using multiple part construction, as discussed above.

As will be appreciated, the head 240 has a symmetrical geometric arrangement which facilitates its use as a standard part irrespective of cylinder configuration. Furthermore, its design allows the use of different types of valves 263, 265 or different operational regimes, providing improved flexibility.

Details of the inlet bridge 271 can be seen in FIGS. 7A and 7B. The inlet bridge 271 is formed from a unitary inlet bridge body 701. Inlet valve apertures 702 a allow the inlet valves 263 to be coupled to the bridge, whilst support apertures 703 are provided to allow the inlet bridge 271 to be supported on the studs 273 as shown in FIGS. 3A to 3D. The support apertures 703 have an enlarged diameter for most of their length to accommodate the biasing springs 274. The inlet bridge 271 also includes a cam follower cutout 704 for retaining a cam follower 277 which is typically mounted on a shaft supported by cam follower support apertures 276 on either side of the cutout 704.

With reference to FIGS. 8A and 8B which show details of an exhaust bridge 272, it will be appreciated that the exhaust bridge 272 has generally similar construction compared to the inlet bridge, but with adaptations to accommodate four exhaust valves 265. Accordingly, the exhaust bridge 272 include four exhaust valve apertures 802, spaced symmetrically about a centre plane defined through its cam follower support apertures 276. In this case, there are two cam follower cutouts 804 for retaining two cam followers 277 of similar construction as used for the inlet bridge 272. The support apertures 803 are also similar to those used in the inlet bridge 272, helping to keep the unique parts count to a minimum.

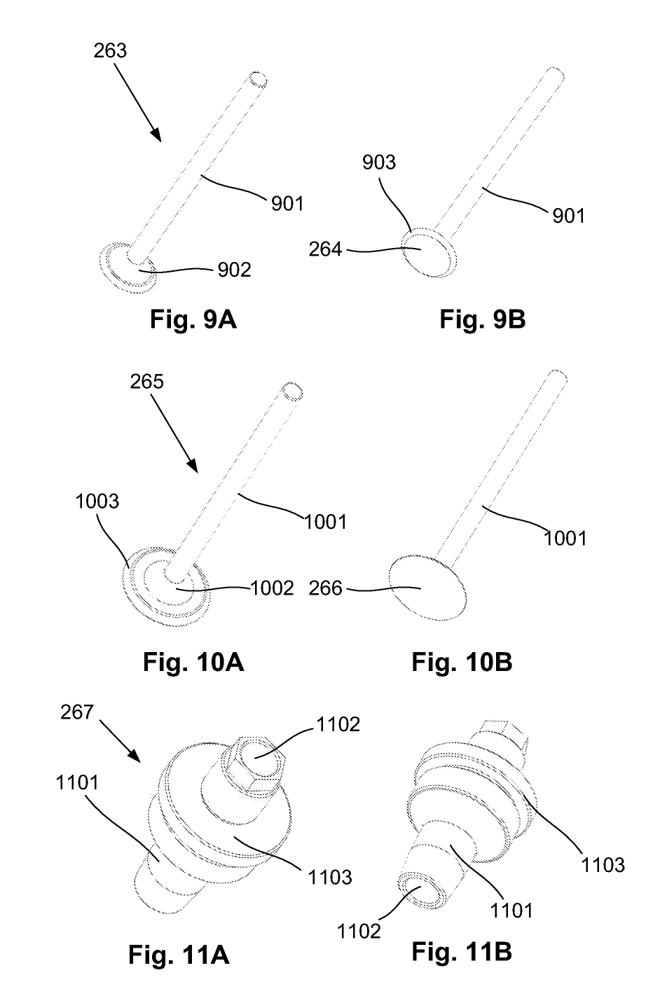

As shown in FIGS. 9A and 9B, the inlet valves 263 include a valve stem 901 which passes through a respective inlet valve aperture 702 on the inlet bridge 271. The inlet valves 263 may be coupled to the inlet bridge 271 using any known technique and preferably the coupling will be adjustable such as through the use of a threaded portion and nuts or other suitable fasteners, so as to allow fine adjustments of the opening and closing operation of the inlet valve 263.

As mentioned previously, the inlet valves 263 in this example have an inverted operation compared to traditional poppet valves, which can provide improved sealing against pressurised gas when closed. The inlet valve 263 includes an inlet valve plug 902 which defines the inlet valve seal 264 on its underside, and which is surrounded by a tapered inlet valve seat engaging portion 903 configured to engage with the inlet valve seat 603 inside the head 240.

An exhaust valve 265 having a more conventional valve construction is shown in more detail in FIGS. 10A and 10B. The exhaust valve 265 includes an exhaust valve stem 1001 extending from a exhaust valve plug 1002, with the exhaust valve seal 264 being defined on the underside, but in this case, an exhaust valve seat engaging portion 1003 is formed on an opposite top site of the exhaust valve plug 1002. Thus the exhaust valve seat engaging portion 1003 engages with the exhaust valve seat 605 formed on the underside of the head 240 when the exhaust valve 265 is raised by the exhaust bridge 272.

FIGS. 11A and 11B show details of a valve guide 267 as used to support and guide each valve 263, 265 in use. A guide body 1101 of the valve guide 267 includes a central guide aperture 1102 through which the stem 901, 1001 of a supported valve 263, 265 can travel linearly in use. Guide flanges 1103 are used to locate the valve guide 267 into corresponding guide apertures 601, which may include shoulder features for positioning the valve guide 267 within the inlet and exhaust apertures 602, 604 formed in the head 240.

It should be understood that, whilst valve assemblies 261, 262 of the present design have been shown to include an assembly of separate components providing the bridge 271, 272 and valves 263, 265, in some embodiments these and other elements of the valve assemblies 261, 262 discussed above may be formed integrally.

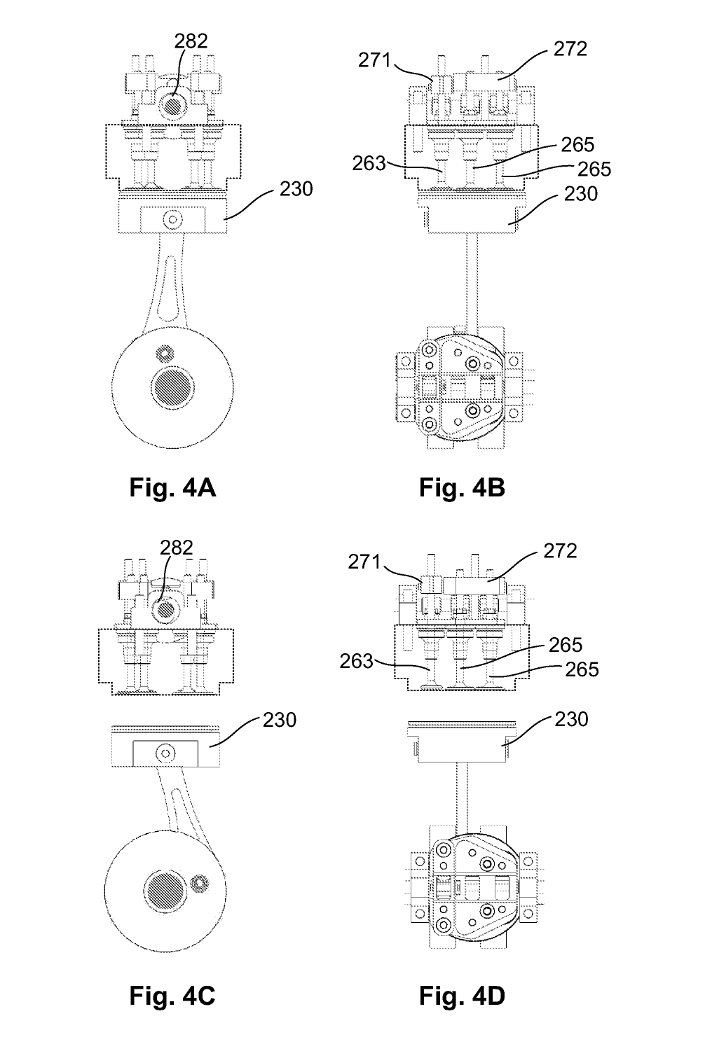

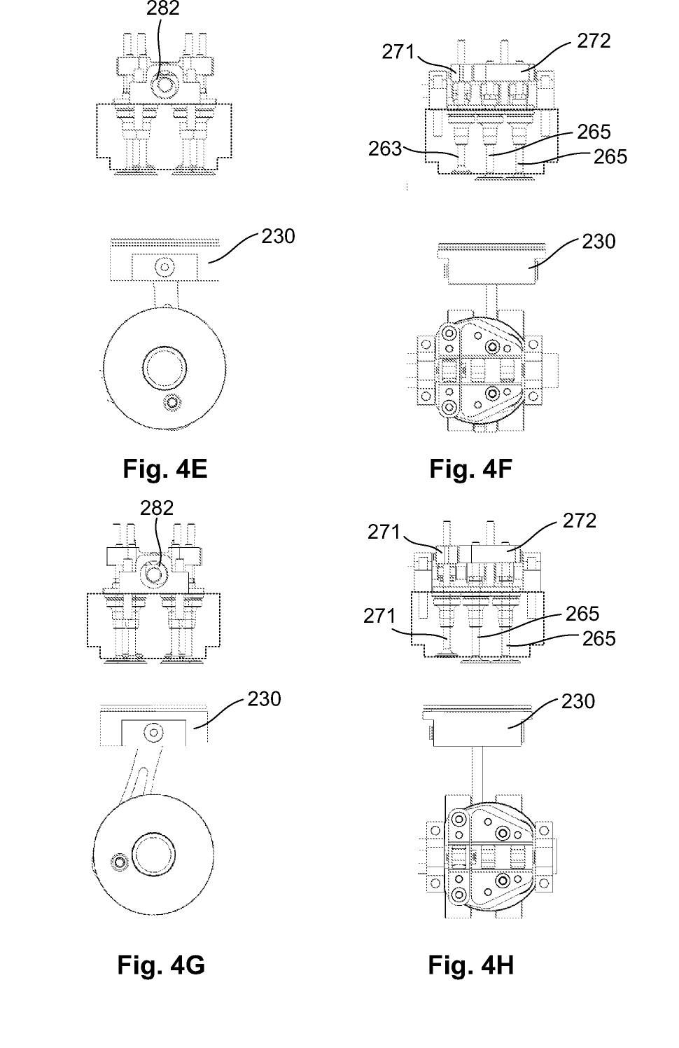

As mentioned previously, the V4 configuration of the air engine 200 causes the reciprocation of each of the four pistons 230 to be offset by 90° with respect to one another. The offset positions of the four pistons 230 at the crankshaft 210 position depicted in FIG. 2D, along with the internal positions of the valves 263, 265, are illustrated in FIGS. 4A to 4H.

FIGS. 4A and 4B show respective side and front views of a first piston 230 which is approaching a top dead centre position. The exhaust cam 282 is lifting the exhaust bridge 272 which causes the exhaust valves 265 to be rigidly held in a closed position. On the other hand, the inlet cam 281 does not lift the inlet bridge 271 but the springs 274 help to ensure the inlet valves 263 are biased downwardly in a closed position.

It is also noted that when the piston 230 is close to top dead centre there is practically no wasted volume in the chamber 221. This is possible because the inlet valves 263 will open into the head 240 at the start of the power stroke and thus have no risk of interference with the piston 230. In contrast, conventional valves which open into the chamber 121 may interfere with the piston unless a suitable volume is provided above the piston 230 at top dead centre or the piston face has depressions for avoiding contact with the valves if these are open at or near top dead centre. As a result, there is minimal or no wasted stroke length with respect to the cylinder and this allows practically instant application of fully pressurised gas to the face of the piston 230, immediately upon opening of the inlet valves 263.

FIGS. 4C and 4D show a second piston 230 which is offset by 90° from the first piston 230 shown in FIGS. 4A and 4B. The second piston 230 is passing through a power stroke in this case. The exhaust valves 265 remain closed due to the exhaust bridge 272 being lifted by the exhaust cam 282 and the inlet valves 263 are also opened for the second piston due to the inlet bridge 271 being lifted by the inlet cam 281.

FIGS. 4E and 4F show a third piston 230, offset from the aforementioned second piston 230 by a further 90°, such that the third piston 230 is approaching bottom dead centre and the end of its power stroke. The inlet valves 263 have now been closed by the biasing action of the springs 274 on the inlet bridge 271. Springs 274 have also biased the exhaust bridge 272 into a lowered position to thereby cause the exhaust valves 265 to open into the chamber 121. Thus, the exhaust valves 265 are ready to allow exhaust gas to be expelled from the chamber 121 during the return stroke.

FIGS. 4G and 4H show a fourth piston 230, offset once more by 90° from the third piston 230 and approximately 270° after top dead centre in this case. As per FIGS. 4E and 4F, the exhaust valves 265 are open to allow exhaust gas to be expelled, whilst the inlet valves 263 remain biased into a closed position.

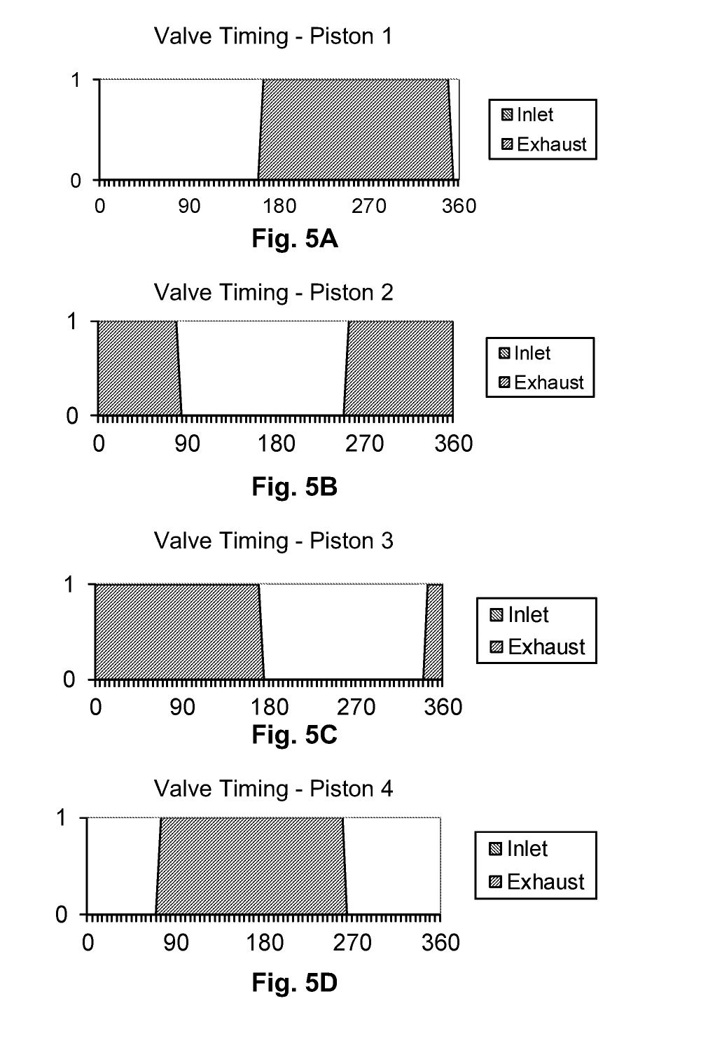

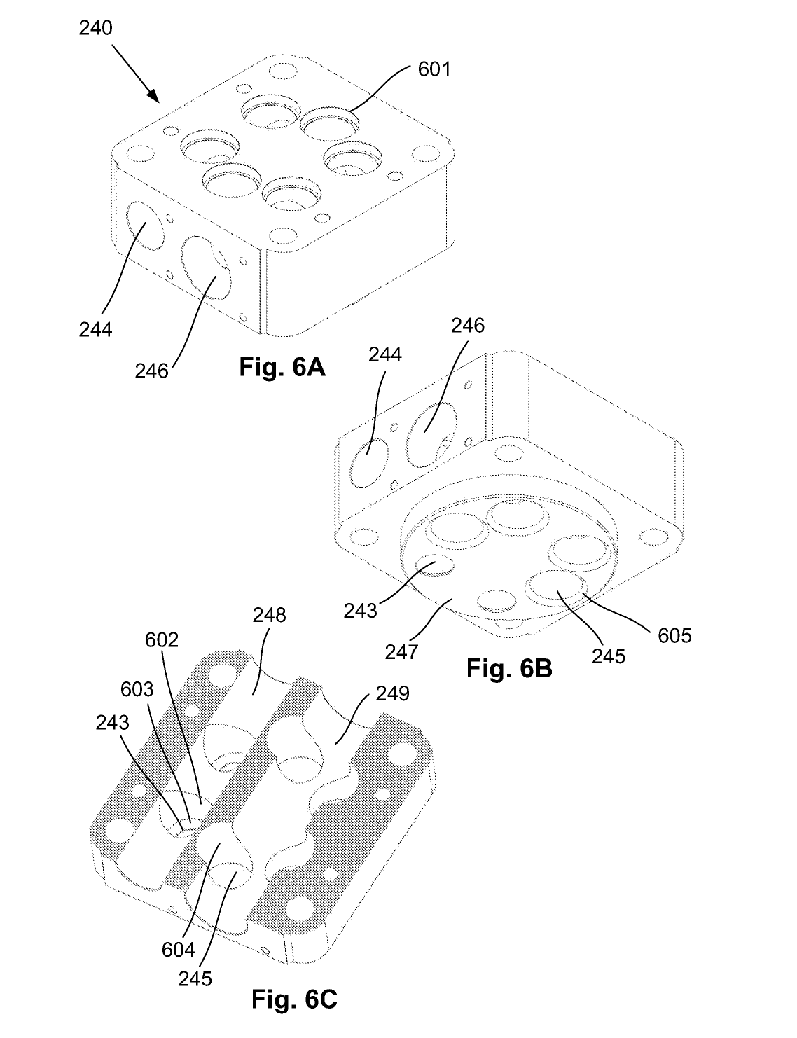

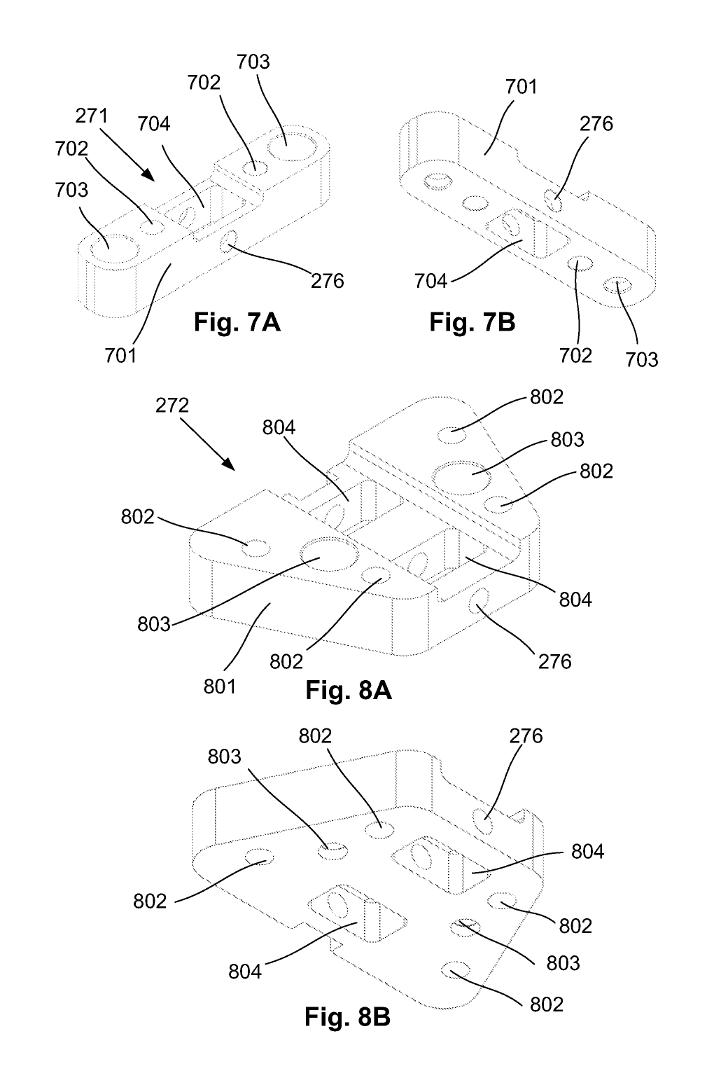

The overall relative valve timing for each of the pistons illustrated in FIGS. 4A to 4H can be better appreciated by comparison of the respective timing charts shown in FIGS. 5A to 5D. The timing charts respectively show when the inlet valves 263 and exhaust valves 265 are open relative to the absolute crank angle which is set at 0° when the first piston is at a top dead centre position.

As can be seen in FIG. 5A where the first piston position corresponds directly with the absolute crank angle, the inlet valves 263 are open from top dead centre to approximately 156° after top dead centre, after which the inlet valves 263 are closed and the exhaust valves 265 are opened at approximately 165° after top dead centre. The exhaust valves remain open throughout the rest of the stroke until 355° after top dead centre.

FIGS. 5B to 5D illustrate similar timing cycles for the second, third and fourth piston 230 respectively, but each are offset by 90° due to the timing diagrams being referenced to the absolute crank angles rather than the local positions of the pistons 230. This allows visualisation of the overlaps between the periods in which the inlet valves 263 are opened and pressurised gas actively drives the respective piston 230. It will be appreciated that at any absolute crank angle there will be at least one piston 230 with open inlet valves 263, and at most crank angles there will actually be two pistons 230 with open inlet valves 263.

This allows the air engine 200 to be readily self-started by simply supplying pressurised gas to the inlet openings 244 of the heads 240 without any special start-up procedures, since the pressurised gas will always be able to start driving at least one piston 230 along a power stroke.

It will be appreciated that the air engine 200 may be operated by supplying pressurised air to the inlet openings 244 of the heads 240, typically via an inlet manifold. The exhaust product will be expanded air which can be removed from the exhaust openings 246 of the heads 240, typically via a separate exhaust manifold. Typically the exhaust air will be at or near atmospheric pressure and may be at a significantly reduced temperature compared to ambient conditions due to its rapid expansion in the air engine 200.

A power generation system may utilise the air engine 200 connected to a suitable source of pressurised air. In one example, the air engine 200 may be supplied with pressurised air stored in a suitable pressure vessel. The flow of pressurised air to the air engine may be controlled to vary the operational speed and power developed by the air engine 200. In another example, the power generation system may include an air compressor which generates pressurised air which may be stored or supplied directly to the air engine as required. In the case where the pressurised air is stored, this may be performed using high pressure storage tanks, such that the pressurised air can be supplied to the air engine on demand. This can also allow further control of the supply pressure and flow rate of the pressurised air to the air engine 200, to thereby control power output as required.

Preferably the air compressor will be powered by a readily available power source, and the air engine 200 can utilise the pressurised air to deliver useful rotational power for other applications. The power source for powering the air compressor may include renewable power sources such as solar cells. Alternatively, the air compressor may be powered by conventional engines or by electric power supplied by a electricity network or stored in batteries.

An electrical generator may be coupled to the crankshaft 210 of the air engine 200 to allow rotational power developed using the pressurised air source to be converted to electrical power. This may allow useful applications of the air engine 200 in remote applications where electrical power or chemical fuel is not available but there is a capability to carry stored pressurised air or compress air locally using an air compressor. It will also be appreciated that power generated by air engine 200 can be stored for later use, such as by having the electrical generator supply electrical power to a battery for storage.

As mentioned previously, the expanded gas output from the air engine 200 as an exhaust stream may be significantly cooler than the surrounding ambient air. This refrigerated exhaust stream may also be used for other cooling applications such as air conditioning or cooling of heat generating equipment.

In one example, the refrigerated exhaust stream from the air engine 200 may be used for cooling a diesel generator, such as in a remote mining application. An air compressor may be powered by diesel and the pressurised air it produces may be used to operate an air engine 200 which is in turn coupled to an electrical generator to supplement the electrical power produced by the diesel generator. The refrigerated exhaust from the air engine 200 can be then fed to a cooling system for cooling the diesel generator.

In another example, an air engine 200 may be used in a vehicle power plant, such as for a long haul prime mover truck. The vehicle power plant may include an internal combustion engine powering a compressor for producing a supply of pressurised air which can be stored or supplied directly to the air engine 200. In one example of a truck power plant, the air compressor may be conveniently powered by a diesel engine, which can operate constantly at peak efficiency and may have significantly lower capacity than would otherwise be required to drive the truck itself. However, the air engine 200 may be sized to deliver sufficient power to drive the truck using the pressurised air. Efficiency benefits can be realised due to the efficient operation of the diesel compressor, compared to the alternative of running a diesel motor to drive the truck itself. It will be appreciated that internal combustion engines other than diesel engines may otherwise be used.

The vehicle power plant as discussed above may also beneficially use the cool exhaust air from the air engine 200 for cooling the combustion engine in use. It will be appreciated that this can further improve the efficiency of the vehicle power plant and can also help to guard against overheating, particularly in extreme environmental conditions and/or during heavy use of the vehicle.

Such a vehicle power plant may also include a capability for storing pressurised air supplied by the air compressor, which can allow pressurised air to be supplied to the air engine 200 on demand. In some examples, the stored pressurised air may be supplied at higher flow rates than may otherwise be provided by the air compressor, thus allowing extra power to be delivered by the air engine 200 when required. Excess pressurised air that is not required by the air engine 200 during periods of lower power demands, such as during descents or braking of the vehicle, may be stored for later use.

It will be appreciated that this arrangement is somewhat analogous to systems used on mining trucks where diesel powered electrical generators generate electricity which is used by electric motors to drive the trucks. This arrangement may eliminate the need for expensive battery systems and high current wiring, by replacing these with a simpler mechanical system. It will also be appreciated that similar vehicle power plant arrangements may be provided for other types of vehicles including boats, tanks, helicopters, excavators or the like. Similar arrangements may also be used in stationary equipment where rotary power is nevertheless required, such as in drilling equipment.

In view of the above, it will be appreciated that systems using the air engine 200 may enable the efficient generation of power in circumstances that may not be particularly well suited to conventional techniques. It is noted large volumes of pressurised air can be conveniently stored for use by the air engine 200 when needed, and new supplies of pressurised air can be continuously produced using renewable resources. In contrast, it is not generally feasible to store large quantities of electrical energy in batteries.

The above discussed features of the reciprocating engine contribute to a uniquely efficient method of harnessing the kinetic power of compressed gas. Preferred embodiments as discussed above combine features that significantly reduce wastage of energy stored in the compressed gas, so as to harness the input of energy to an unparalleled level of efficiency.

This efficiency may be achieved by way of the unique mechanically operated valve and head configuration disclosed in detail above. The valve and head configuration allows a long power stroke (of anywhere up to 180 degrees operating in a 2-stroke configuration), provides for rapid & precise repeatability, control and efficiency of flow actuation and gas transfer. This can result in substantially greater power & torque output for input energy (compared to other analogous reciprocating engine designs).

It will be appreciated that the design of the valve arrangements including the use of a bridge as discussed allows an engine to be produced which that has reduced internal resistance for the fuel source to overcome which can lead to more efficient operation. The engine may be constructed with an intrinsically low rotational inertia resulting in relatively easier turnover of the engine, irrespective of whether valves are open to avoid the need to compress air in the cylinder. There are several reasons for this, and some of these are set out below, although it should be understood that the following is not an exhaustive list.

First, it is noted that the design of the valve arrangements allows valves to operate without requiring the use of highly tensioned springs to return the valves to their resting state. Accordingly, the rotation of the engine doesn't need to overcome resistance due to highly tensioned springs, meaning less energy is expended operating the valve system, and more useful power is available at the crankshaft. This can be contrasted to high performance engines such as those found in drag cars, where the engines have springs with extremely high spring tension to snap the valves closed as fast as possible.

The valve arrangements discussed above can eliminate the need for such spring configurations. The only force required by biasing members such as springs is a force necessary to overcome the force applied by the internal chamber pressure exerted on the face of the valve. As such, a biasing member merely of slightly higher tension than the force acting on the valve face surface is all that is strictly required. In fact, in the case of inlet valves for an air engine, biasing members may not even be required given the highest pressure will typically be on the opposite side of the valves, although a spring may still be used for cushioning or to assist in responsiveness of the valves.

Furthermore, it is noted that the valve arrangement can operate with relatively small valve movements, and in the case of actuators in the form of cams, this can allow smaller cam geometries than in conventional cam operated valve designs. This can reduce the cam contact speed required per revolution, can also reduce wear, and is beneficial for camshaft balance given that the weight and throw of each cam lobe may be reduced.

By allowing linear actuation of valves in a compact arrangement, the engine design also provides significant improvements compared to conventional angled poppet valve arrangements and particularly traditional rocker arm systems, by removing the mechanical disadvantage of angular movement and long travel distances which require more intrinsic engine power to overcome. Embodiments of the valve arrangement in which cams are used as the actuators have the benefit that the cam lobes act directly on a cam follower of the bridge to effectively and positively move the bridge coupled to the valves. As such, the bridging system eliminates this mechanical disadvantage having a more advantageous ratio of leverage. It is also noted that embodiments of the engine can also provide improved mechanical efficiency through reduced intrinsic restriction on the engine due to the use of favourable mechanical advantage in the connection between the crankshaft and the camshaft. In preferred embodiments, the camshaft timing pulley is up to twice the diameter of the cams at the highest lobe point.

As mentioned above, aspects of the reciprocating engine configurations discussed above may also find application to internal combustion engines. For example, the valve arrangements including bridges for simultaneously controlling the operation of multiple valves in a compact and mechanically simplified configuration may also be useful in internal combustion engines. It will be understood that the above examples may be adapted to internal combustion engine applications such as by changing the camshaft timing relative to the crankshaft to allow 4-stroke operation and by reconfiguring the inlet valves similar to the exhaust valves

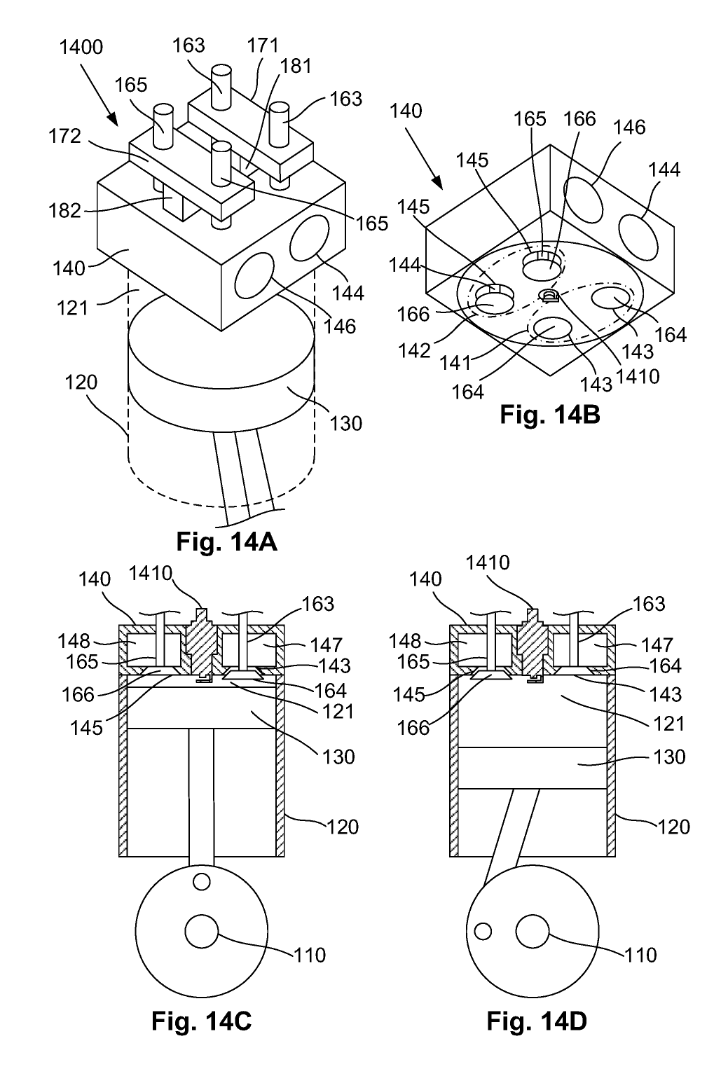

An example embodiment of an internal combustion engine 1400 is shown in FIGS. 14A to 14D. It will be noted that this example is similar to that described with reference to FIGS. 1A to 1P, and as such, similar features have been assigned similar reference numerals.

An internal combustion engine 1400 in accordance with this example generally includes a crankshaft 110 (not shown), a cylinder 120 defining an internal chamber 121, a piston 130 positioned in the chamber, the piston 130 being connected to the crankshaft 110 and being configured to reciprocate inside the chamber 121.

The internal combustion engine also includes a head 140, although in this case the head 140 may include different construction features compared to those of previous examples to accommodate an ignition source 1410, such as a spark plug as illustrated in FIGS. 14B to 14D, or any other known type of ignition source 1410. It will be appreciated that an ignition source 1410 is not essential in the case of a diesel engine, although the head 140 may still include other adaptations depending on the engine type. For example, the head 140 may be adapted to accommodate a glow plug, fuel injector, or the like in the case of a diesel engine.

As in previous examples, the head 140 is attached to the cylinder 120 and closes the chamber 121 at an end opposing the piston 130, and head 140 includes port group 141, 142 including two or more ports 143, 145 for allowing fluid communication between the chamber 121 and a respective manifold. In this case, an inlet port group 141 includes two inlet ports 143 and an exhaust port group 142 includes two exhaust ports 145. For each port group 141, 142, there is provided a valve arrangement 161, 162 coupled to the head 140. Each valve arrangement 161, 162 includes, for each port 143, 145 of the port group 141, 142, a valve 163, 165 for operatively controlling fluid flow through the respective port 143, 145.

A bridge 171, 172 is coupled to the valves 163, 165 for each valve arrangement 161, 162, wherein movement of the respective bridge 171, 172 relative to the head 140 causes synchronised operation of the valves 163, 165 coupled thereto. An actuator 181, 182 is provided for causing each bridge 171, 172 to move based on the reciprocation of the piston 130.

As can be seen in FIGS. 14B to 14D, the configuration of the inlet ports 143 and corresponding inlet valves 163 is different compared to previous examples relating more specifically to air engines. In particular, the inlet valves 163 in this case are similar to the exhaust valves 165 in that both types of valves 163, 165 open their respective ports 143, 145 by moving into the chamber 121, and have generally similar valve seal 164, 165 configurations. FIG. 14C shows open inlet valves 163 as the piston 130 passes top dead centre commencing an intake stroke, whilst FIG. 14D shows open exhaust valves 165 as the piston 130 travels upwardly on an exhaust stroke. It is noted that the piston 130 face may include depressions to avoid interference with the ignition source 1410 and inlet valves 163 which project into the chamber 121 when opened when the piston 130 is at top dead centre, allowing reduction in the dead volume between the piston 130 and the head 140.

It will be recalled that the inlet valves 163 of previous air engine examples were able to open by moving into the head 140, which may be beneficial in view of the pressures applied to the inlet valves 163 by the supplied pressurised air. Such an arrangement is of little benefit in the case of an internal combustion engine 1400 where air is supplied and the valve seals 164, 165 are better adapted to withstand pressures which are generated within the chamber 121 due to combustion.

Accordingly, the inlet valves 163 and exhaust valves 165 may each be positively closed when respective actuators 181, 182 move the bridges 171, 172 away from the head 140, similar to the exhaust valves 165 of previously described examples. The inlet valves 163 and exhaust valves 165 may be opened by a biasing member such as a spring, although it is also possible to have the actuators 181, 182 cause movement of the bridges 171, 172 towards the head 140 to positively open the valves 163, 165.

It is noted that a similar arrangement using inlet valves 163 and exhaust valves 165 which are each positively closed in this fashion can also be used in air engines similar to those described above. It should also be appreciated that the valves 163, 165 in the internal combustion engine example may alternatively be positively opened due to the actuators 181, 182 and closed by a biasing member.

In any event, it will be understood that the use of valve arrangements 161, 162 in which a respective bridge 171, 172 is moved by an actuator 181, 182 to effect synchronised operation of the corresponding valves 163, 165 will provide similar benefits as discussed per previous examples.

Furthermore, when applied to an internal combustion engine, it is considered that valve arrangements 161, 162 as described above can allow improved valve durability and actuation speed, since the valves 163, 165 can be positively closed (and optionally positively opened) without relying on spring tension to return valves as in conventional internal combustion engines. This will particularly be beneficial in high performance engines where valve closing responsiveness can be a limiting factor with regard to operating speeds. In some engines in accordance with the above examples, springs may not even be required to cause opening or closing of valves, and may only be required to provide a cushioning effect.

In view of the discussion above, it will be appreciated that valve arrangements having positively closed valves may exhibit desirable performance improvements, especially in internal combustion engines. Examples of such valve arrangements have already been described in the context of multi-valve engines, although similar principles may also be usefully applied to engines having only a single inlet valve and a single outlet valve.

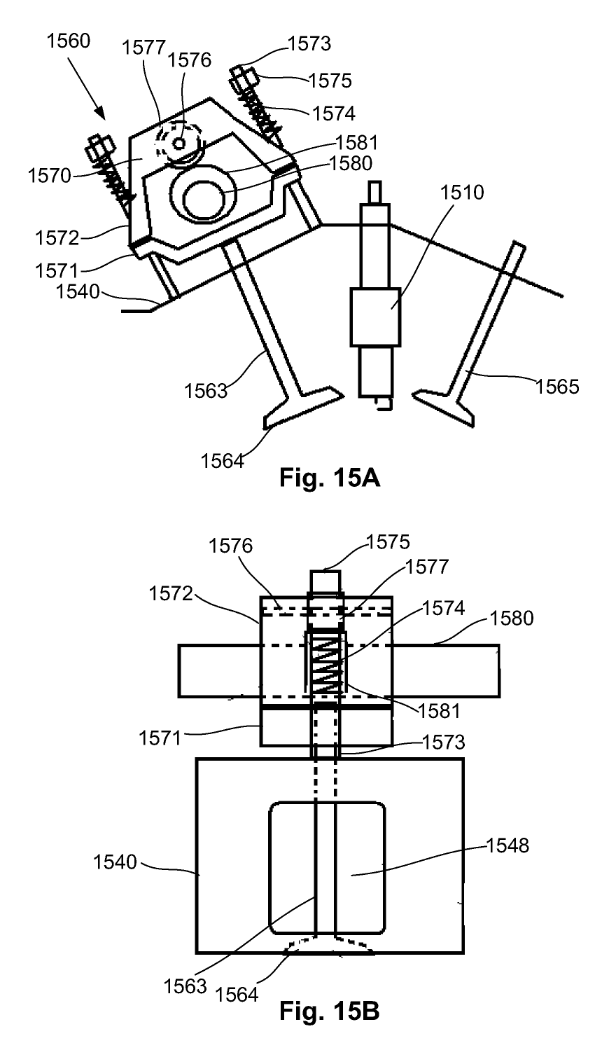

Accordingly, an example of a valve arrangement 1560 and a corresponding head 1540 for an engine having a single inlet valve and a single outlet valve will now be described with reference to FIGS. 15A and 15B.

It will be understood that a reciprocating engine utilising the valve arrangement and head 140 depicted in FIGS. 15A and 15B will include typical reciprocating engine features of a crankshaft, a cylinder defining an internal chamber, a piston positioned in the chamber, the piston being connected to the crankshaft and being configured to reciprocate inside the chamber, although these features have been hidden given the particular configuration of the valve arrangement 1560 and the head 1540 is of primary interest in this example.

The engine further includes the head 1540 attached to the cylinder and closing the chamber at an end opposing the piston, and the valve arrangement 1560. The head 1540 includes a port for allowing fluid communication between the chamber and a respective manifold, and the valve arrangement 1560 includes a valve 1563 for operatively controlling fluid flow through the port.

In this case only a single valve 1563 is provided in the valve arrangement 1560. This valve 1563 is assumed to be an inlet valve 1563 for the purpose of this example. For completeness, another valve 1565 is indicated in FIG. 15A and this is assumed to be an exhaust valve 1565. It will be understood that a similar valve arrangement can be used for an exhaust valve 1565, although this has been hidden in FIG. 15A for the sake of clarity.

The valve arrangement 1560 includes a bridge 1570 coupled to the valve 263, wherein movement of the bridge 1570 in a first direction causes the valve 263 to close and movement of the bridge 1570 in a second direction causes the valve 263 to open. The valve arrangement 1560 further includes a closing actuator 1580 for causing the bridge 1570 to move in the first direction based on the reciprocation of the piston, to thereby positively close the valve, and at least one biasing member 1574 for biasing the bridge 1570 towards the second direction.

This form of valve arrangement 1560 allows the valve 1563 to be mechanically moved into a closed position against the biasing member when the closing actuator 1580 acts on the bridge 1570, but when the closing actuator 1580 is not acting on the bridge the biasing member 1574 may be used to return the valve 1563 to a natural open position. It will be appreciated that the resulting valve operation is opposite to that of conventional poppet valves in internal combustion engines or the like, where the valves are traditionally opened mechanically and rely on a spring to return the valve to a closed state.

As discussed above, there are significant advantages in providing valve arrangements having positive valve closure when compared to such conventional arrangements. To reiterate, these advantages include a significant reduction in the intrinsic resistance to the rotation of the engine when the positively closing valve arrangement 1560 is used instead of a traditional positively opening valve configuration.

It is noted that a major source of rotational resistance in conventional internal combustion engines is the spring tension that is required to reliably close the traditional positively opening valves. The springs of conventional engines can only return the valve to its closed position at a given speed due to their inherent dynamic response characteristics which are dependent on factors including the spring tension and valve mass. At high operating speeds the valve may not have time to be successfully closed. This problem is known as valve float. If a valve doesn't close in sufficient time in a conventional internal combustion engine, the result is either lost power because of reduced compressed gas that escapes through the still open valve, or, more critically, interference between the valve and the piston which can cause extensive damage to the valve and/or the piston. Accordingly, valve float has traditionally limited the maximum operating speed of conventional engines.

Traditionally, the problem of valve float in conventional poppet valve configurations has been only partially mitigated through controlling the properties of the spring. For instance, if higher operating speeds are required from a conventional engine, heavier valve springs may be needed to ensure the valves can be reliably returned to the closed position. This comes at the expense of an increased load on the camshaft when the springs are compressed during opening of the valve, and this in turn generates higher rotational resistance in the common scenario where the camshaft is coupled to the engine using a timing belt or the like.

In contrast, in valve arrangements 1560 as per the present example, the problem of valves not properly closing due to valve float at high speeds are eliminated. The valve 1563 can be moved into the closed position at ever increasing engine speeds because these are positively closed based on the reciprocation of the piston, and there is no reliance on springs or other time-limited biasing arrangements in the closing operation of the valve 1563.

Whilst the valve arrangement 1560 includes a biasing member 1574, such as a spring coupled to the bridge 1570, this may be only provided for facilitating the opening operation of the valve 1563. In the present example, the valve arrangement 1560 is configured so that the biasing member 1574 causes the valve 1563 to open whenever the closing actuator 1580 is not being used to positively close the valve 1563. This configuration has been found to require a greatly reduced spring tension compared to that which would be required in a conventional configuration.

In particular, the spring tension required for opening the valve 1563 may be calculated to merely counteract the maximum internal chamber pressure being applied to the face of the valve 1563 at the time the valve 1563 needs to be opened. It is noted that the required spring tension remains a constant throughout the rev range regardless of increased speed. In preferred embodiments of the valve arrangement 1560, the spring tension for springs used to provide biasing members 1574 for opening the valve 1563 can be set to approximately half the spring tension required for closing a similar valve of a conventional internal combustion engine of corresponding size and performance.

Accordingly, it will be appreciated that the valve arrangement 1560 having positively closing valves 1563 helps to reduce the intrinsic resistance by allowing the use of springs having relatively light spring tension.

In this example, the movement of the bridge 1570 in the first direction involves the bridge 1570 moving away from the head 1540 and the movement of the bridge 1570 in the second direction involves the bridge 1570 moving towards the head 1540. This allows the valve 1563 to have a generally conventional valve seal 1564 arrangement and to open by extending the valve seal 1564 into the chamber and to close by seating the seal 1564 in the port formed in the head 1540. However, it will be appreciated that other configurations for allowing positive valve closure through the actuation of a bridge 1570 may be possible.

As depicted in FIG. 15A, the valve arrangement 1560 may be incorporated into an internal combustion engine including an ignition source such as a spark plug 1510. It will be appreciated that the valve arrangement 1560 can be positioned in such a way as to allow conventional spark plug 1510 positioning perpendicular to the piston face.

In other internal combustion engines, such as a diesel engine, a spark plug 1510 may not be required although other standard engine features such as a glow plug or a fuel injector may be provided. Alternatively, the valve arrangement 1560 may be used with a pressurised gas engine configured to be driven by compressed gas, which may operate in a similar manner as discussed above.

Further preferred (albeit optional) features of the valve arrangement 1560 as shown in FIGS. 15A and 15B will now be described.

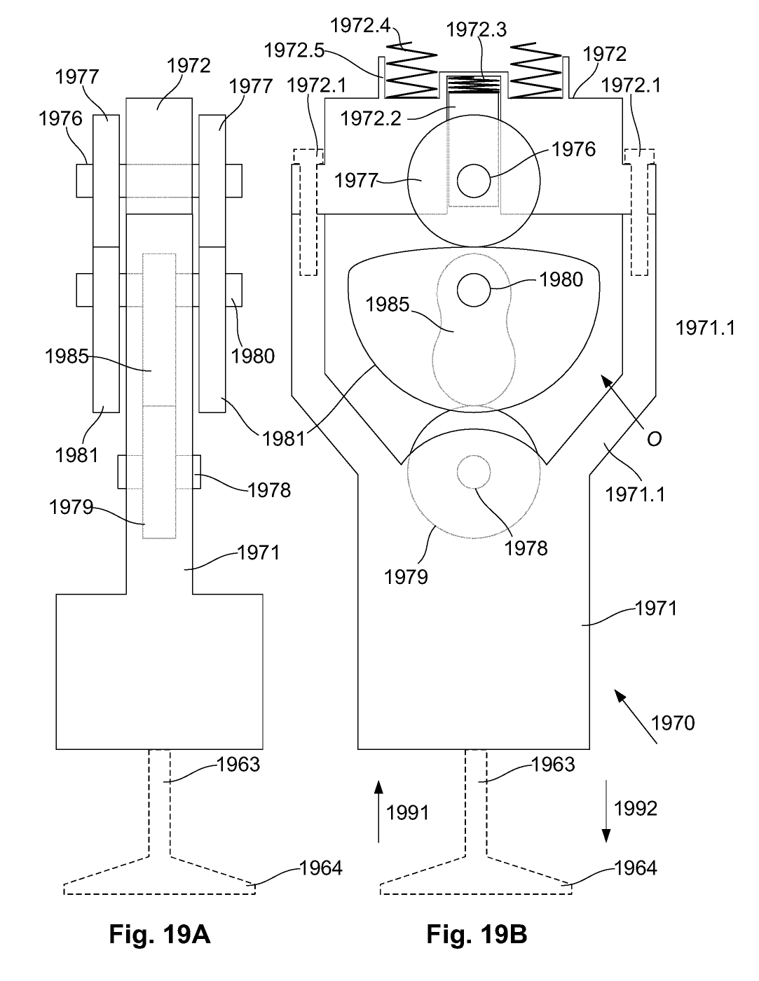

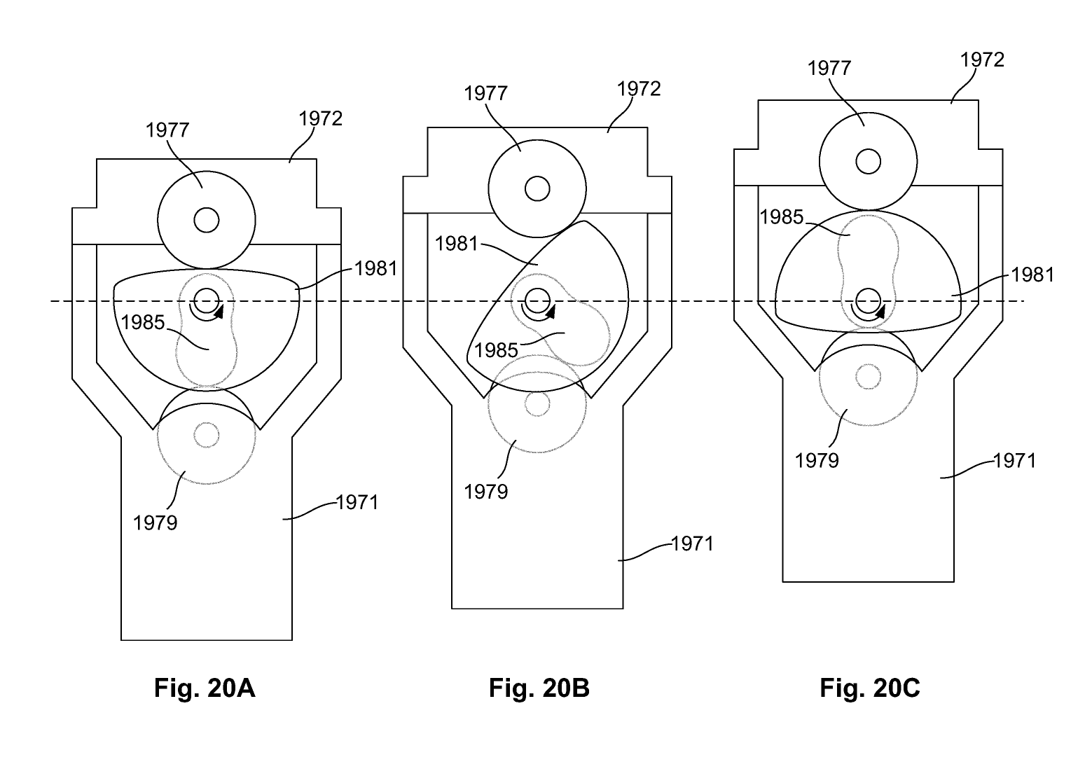

As per previous examples, the closing actuator may be provided in the form of a camshaft 1580 including at least one cam 1581 mounted thereon. In this regard, although a single cam 1581 is shown, multiple cams may be provided spaced apart on a common camshaft, with each of these having a respective follower, as will be described in more detail below with respect to the example of FIGS. 19 and 20. For the purpose of explanation of this example, reference will be made to a single cam 1581, although it will be appreciated that this is not intended to be limiting.

The camshaft 1580 will typically be rotationally coupled to the crankshaft of the engine. Thus, the cam 1581 may be configured to control the movement of the bridge 1570 depending on the rotational position of the crankshaft. It will be appreciated that the valve arrangement 1560 can be mounted over the head 1540 using an overhead cam 1581 arrangement. The bridge 1570 may in turn include a cam follower 1577 for engaging the cam 1581, as shown in FIG. 15A. Accordingly, this provides a low friction arrangement for converting the rotational motion of the crankshaft into the required movement of the valve 1563 for closing and opening the valve 1563 as required.

The bridge 1570 may include a first bridge portion 1571 (or main bridge body) to which the valve 1563 is coupled and a second bridge portion 1572 (or bridge cap) including the cam follower 1577. In this particular example, the bridge 1570 defines a cavity between the first bridge portion 1571 and the second bridge portion 1572, so that the camshaft 1580 is able to extend through the cavity. This structural configuration of the bridge 1570 provides a convenient geometric arrangement for allowing the valve 1563 to be lifted into the closed position when the bridge 1570 is actuated by lobes of the cam 1581.

As mentioned above, each biasing member may be provided in the form of a spring 1573 coupled to the bridge 1570. In the present example, each spring 1574 is coupled to the bridge 1570 so that the spring 1574 is compressed when the bridge 1570 is moved in the first direction using the cam 1581 on the cam shaft 1580 (or any other suitable closing actuator) to positively close the valve 1563 so that the compressed spring 1574 urges the bridge 1570 in the second direction to thereby open the valve 1563 when the cam 1581 is not being used to positively close the valve 1563.

In other words, the springs 1574 provide a biasing tension which is overcome by the cam 1581 acting on the cam follower 1577 during the mechanical closure of the valve 1563, whilst the opening of the valve 1563 is achieved through the release of the biasing tension.

As shown in FIGS. 15A and 15B, each spring 1574 may be mounted on a stud 1573 extending outwardly from the head 1540. In a similar arrangement as previously described, each spring 1574 may be retained on the stud 1573 using a retainer 1575, so that the springs 1574 are effectively coupled to the bridge 1570. In this example, the valve arrangement 1560 includes a pair of springs 1574 arranged symmetrically about the valve 1563, allowing for balanced biasing of the bridge 1570 to thereby ensure the valve 1563 is opened linearly.

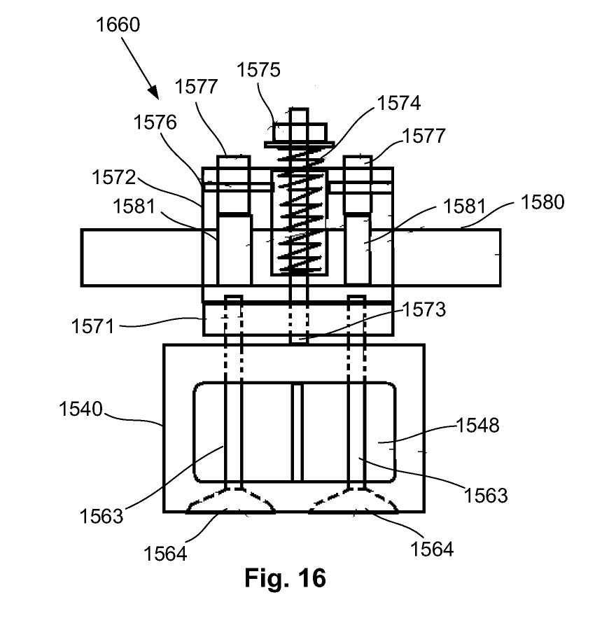

In view of the above examples of engines having bridges used for the synchronised operation of multiple valves, it will also be appreciated that the type of valve arrangement 1560 described with reference to FIGS. 15A and 15B may also be used with multiple valves. To illustrate this, FIG. 16 shows a further example of a valve arrangement 1660 generally similar to that discussed above but including two valves 1563 coupled to the same bridge 1570. Each valve 1563 is for operatively controlling fluid flow through a respective port, whereby movement of the bridge 1570 causes synchronised operation of the two valves 1563.

By comparison of FIG. 16 and FIG. 15B, it will be understood that this valve arrangement 1660 includes generally similar features as per the earlier described, albeit with some features being duplicated or otherwise adapted to accommodate two valves 1563 instead of the single valve 1563 of the previous example. In any event, similar principles of operation will apply, with the further benefits of mechanically synchronised operation of the multiple valves 1563, along with the ability to operate multiple valves using a single cam 1581 if desired.

Whilst the examples of FIGS. 15A, 15B and 16 show arrangements including a closing actuator 1580 provided by a cam of the like for ensuring positive closing of the valve 1563 only, it will be appreciated that other examples of engines may be provided which also allow for positive opening of the valve 1563. In one example, the valve arrangement 1560 may additionally include an opening actuator for causing the bridge 1570 to move in the second direction based on the reciprocation of the piston, to thereby positively open the valve 1563. It will be appreciated that this may be achieved, for example, by using an additional cam configured to actuate the bridge in an opposite direction compared to the cam for providing the closing actuator, where the two cams will preferably have complimentary profiles to ensure only one of the cams is positively actuating the bridge at any one instant.

Irrespective of whether the engine is configured to only positively close the valve, with the biasing member being used to open the valve, or both positively close and open the valve, the valve arrangement may nevertheless include a biasing member, and may be configured such that the biasing member cushions the closing of the valve.

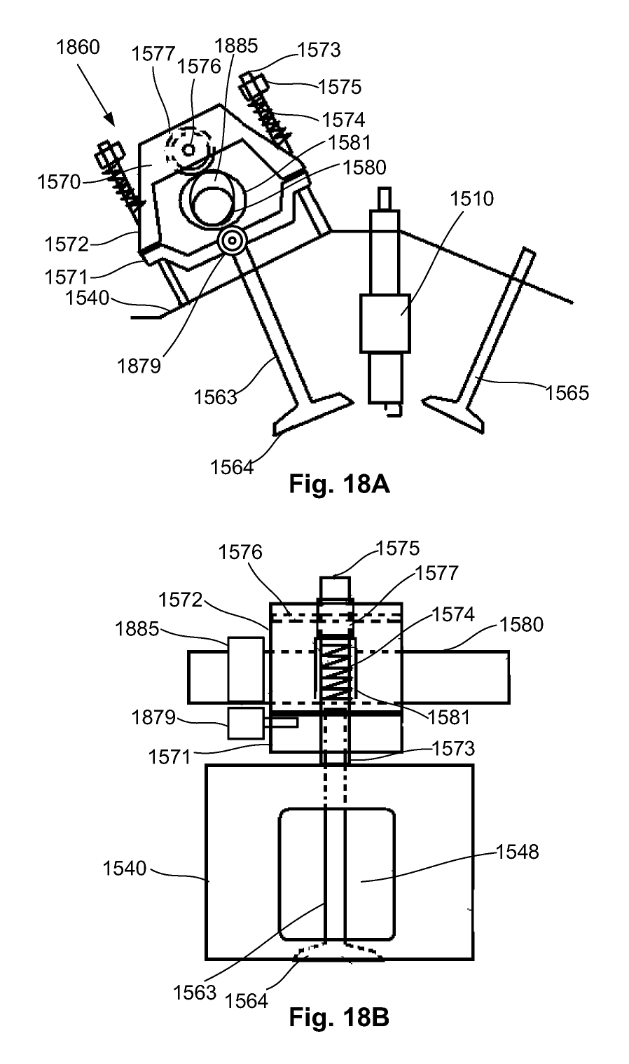

A further example of a valve arrangement 1860 is shown in FIGS. 18A and 18B. The valve arrangement 1860 is generally similar to the previous example of the valve arrangement 1560 of FIGS. 15A and 15B and common features have been assigned the same reference numerals as the previous example. However, in this case, the valve arrangement 1860 includes additional features to improve valve opening in cases where significant pressure may need to be overcome in order to break the seal between the valve and the port when the valve is closed.

Such a situation may arise, for example, in internal combustion engines, where the exhaust valve needs to be opened against increased pressure following combustion. Whilst the biasing member may be configured to cause the valve to open when the closing actuator is not being used to positively close the valve, as per the previous example, this may necessitate the use of a strong spring or other suitably strong biasing member to reliably break the valve seal and open the valve against the pressure in the chamber. The use of a stronger biasing member may undesirably increase resistance to the operation of the engine.

In the example of FIGS. 18A and 18B, this potential problem is addressed by providing, as part of the valve arrangement 1860, a seal breaking actuator 1885 for causing the bridge 1570 to move in the second direction (towards the head 1540 in this example) to positively break a seal between the port (not shown) and the valve 1563 after the valve 1563 is closed.

Thus, the seal breaking actuator 1885 acts as a special form of the opening actuator mentioned above for positively opening the valve 1563. Whilst an opening actuator may be used for causing the bridge 1570 to move in the second direction to completely open the valve 1563, this is not essential for the seal breaking actuator 1885. Rather, the seal breaking actuator 1885 may be configured to merely provide sufficient movement of the bridge 1570 to overcome the chamber pressure and break the seal to allow the remaining opening movement to be provided by the biasing member 1574. It will be appreciated that this can allow a relatively weaker biasing member 1574 to be used since this no longer needs to provide a biasing force sufficient for breaking the valve seal. The seal breaking actuator 1885 may only act on the bridge 1570 for a short segment of the engine cycle to initiate the opening of the valve 1563.

The closing actuator may be provided by a first cam 1581 mounted on a camshaft 1580 that is rotationally coupled to the crankshaft, as per the previous example. In this example, the seal breaking actuator may be provided by a second cam 1885 mounted on the same camshaft 1580. The first cam 1581 and the second cams 1885 are thus configured to control the movement of the bridge 1570 depending on a rotational position of the crankshaft. It will be appreciated that the closing and seal breaking actuators will be directly synchronised as these are provided on the same camshaft 1580.

As best seen in FIG. 18A, the first cam 1581 includes a first cam lobe and the second cam 1885 includes a second cam lobe. Upon rotation of the camshaft 1580, the first cam lobe urges the bridge 1570 in the first direction to thereby positively close the valve 1563 and the second cam lobe urges the bridge 1570 in the second direction to positively break the seal.

A cam arrangement of this type can be said to include a primary closing cam (the first cam 1581) and a secondary “kicker” cam (the second cam 1885), given its function to provide a short kick to break the seal and allow the biasing member 1574, in the form of a spring or the like, to bias the valve 1563 into the open position.

It will be appreciated that the seal breaking actuator, provided by the kicker cam (second cam 1885), may impart some momentum to the valve 1563 which can also assist in moving the valve 1563 towards the open position without requiring significant biasing force from the biasing member 1574. Nevertheless, the biasing member 1574 may still be used to cushion the closing of the valve 1563 as mentioned above for when an opening actuator is used.

To allow this operation, the bridge 1570 may include a first cam follower 1577 for engaging the first cam 1581 and a second cam follower 1879 for engaging the second cam 1885. It will be appreciated that, in the depicted example, the second cam follower 1879 will engage the second cam 1885 and thus cause the valve seal to be broken when the first cam follower 1577 is disengaged from the first cam 1581, i.e. when the closing actuator is not positively closing the valve 1563.

As per the previous example described with reference to FIGS. 15A and 15B, the bridge may include a first bridge portion 1571 to which the valve 1563 is coupled and a second bridge portion 1572 including the first cam follower 1577. However, in this example, the first bridge portion 1571 may further include the second cam follower 1879. In this example, the camshaft 1580 extends between the first and second bridge portions 1571, 1572, particularly in a cavity formed between those two portions as discussed above. This can allow for a compact arrangement.

In some examples, the valve 1563 may be coupled to the bridge 1570 using a valve cartridge including a preloading spring (not shown) or the like for preloading the valve 1563. The second cam follower 1879 may be integrated with the valve cartridge so that the preloading spring also provides some cushioning of the action of the seal breaking actuator on the valve 1563.

As shown in FIG. 18B, the second cam 1885 for providing the seal breaking actuator is positioned on the camshaft 1580 with an offset spacing from the first cam 1581, and the second cam follower 1879 is offset from the first cam follower 1577 by the same amount. Whilst an offset arrangement of this type is not essential, this may be required to allow the use of separate cams on the same camshaft 1580 and to also avoid interference with the valve 1563 which is also coupled to the first bridge portion 1571.

It will be appreciated that the valve arrangement 1860 shown in FIGS. 18A and 18B can allow for reductions in the amount of rotational resistance due to the biasing spring compared to valve arrangements which rely completely on the biasing member 1574 for opening the valve 1563, but without requiring engagement between an actuator and the bridge 1570 throughout the entire opening portion of the engine cycle as may be the case when an opening actuator is used to positively open the valve 1563. Accordingly, this can help to remove the need for the tight manufacturing tolerances that may be needed for both completely positively closing and opening the valve 1563.

The techniques described above can also be applied to piston machines more generally. In this regard, the term piston machine is understood to encompass reciprocating engines, as well as compressors.

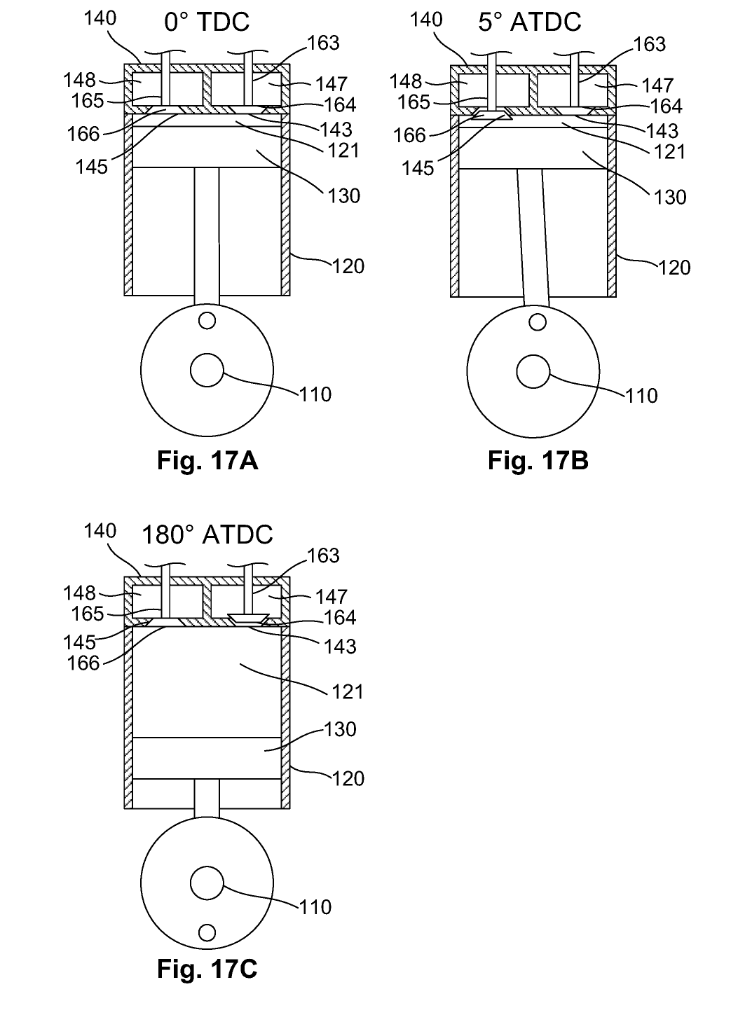

In one example, a compressor can have an arrangement substantially similar to that of the reciprocating engines described above. However, in this example the timing of valve actuation will typically be modified and accordingly, timing arrangements for using the reciprocating engine of FIGS. 1A to 1D will now be described with reference to FIGS. 17A to 17C.

In this example, the valve 165 acts as an inlet valve, allowing air to flow from the chamber 148 into the piston chamber 121, whilst the valve 163 acts as an outlet valve, allowing compressed air to be supplied via the chamber 147.

FIG. 17A shows the inlet valves 165 and outlet valves 163 closed at TDC. As the shaft 110 rotates, the inlet valve 165 open at 5° ATDC, whilst the outlet valve 163 remains shut, with this configuration being retained until 180° ATDC, allowing air to be drawn into the piston chamber 121 during the down stroke of the piston. At 180° ATDC the outlet valve 163 opens, whilst the inlet valve 165 closes allowing pressurised air to be supplied via the chamber 147. This configuration is allowed to continue until TDC, at which point the outlet valve 163 closes, allowing the process to repeat.

A further example of a valve arrangement will now be described with reference to FIGS. 19A and 19B.

In this example, the valve arrangement includes a bridge 1970 including first and second bridge portions 1971, 1972. The first bridge portion 1971 includes arms 1971.1 that couple to the extending second bridge portion, so that the bridge 1970 extends around an opening O through which a camshaft passes. Although two arms are shown in this example, this is for the purpose of illustration only and in practice any number of arms could be used. Thus, a single arm could be used to define a “C-shaped” bridge, whilst more than two arms, for example in the form of parallel spaced apart arm pairs, could be used to provide additional strength. It will also be appreciated that whilst the bridge is formed from two body portions, this is not essential and a single body portion could be used.

The first bridge portion 1971 supports a second cam follower 1979 rotatably mounted thereto via an axle 1978. A valve seal 1964 is also coupled via a valve stem 1963 to the first bridge portion 1971 using a suitable coupling, such as by having the valve stem threadingly engage an opening the second bridge portion.

The second bridge portion 1972 supports a first cam follower 1977 rotatably mounted thereto via an axle 1976, and can be coupled to the arms of the first bridge portion 1971 via a suitable coupling, such as bolts 1972.1 passing through the second bridge portion and into the arms 1971.1, or through an interference coupling or the like.

In this example, a closing actuator is provided in the form of a cam 1981 mounted on a camshaft 1980, which engages with the first cam follower 1977 to thereby control movement of the bridge 1970 upon rotation of the camshaft. Thus, the cam 1981 may be configured to control the movement of the bridge 1970 depending on the rotational position of the camshaft. In particular, the cam 1981 can be used to urge the bridge 1970 in a first direction 1991 as shown in FIGS. 20A to 20C, so that the valve seal 1964 sealingly engages a valve seat, and then release the bridge 1970 allowing the bridge 1970 to move in the second direction to thereby release the valve seal 1964.

As previously described, in order to assist valve opening a biasing mechanism can be used. In this example, a seal breaking actuator 1985 in the form of a second cam mounted on the camshaft 1980 is used to urge the bridge 1970 in the second direction 1992. In the previous example of FIGS. 18A and 18B, the biasing mechanism is used as a “kicker” cam to break the seal, with a second biasing mechanism, such as a spring, keeping the valve open. In this instance however, the second cam 1985 operates to prevent the seal closing while the cam lobe engages the second cam follower 1979. This is particularly in situations in which the valve seal 1964 can bounce causing the valve to close during the open portion of the cycle, as occurs for example during high revving scenarios. By providing the second cam 1985, this prevents the valve seal 1964 returning to the closed position until it is positively closed by the action of the first cam.

It will be appreciated that either one or more of a spring or second cam 1985 could be provided to assist in opening the valve and/or preventing inadvertent valve closure, but that these are not required in all circumstances and so alternatively arrangements with no spring or second cam 1985 could be used, for example in low revving situations, as described previously. Thus, for example one or more springs 1972.4, coupled to the second bridge portion 1972.2 could act on the bridge to urge the bridge in the second direction to thereby help on the valve, either as an alternative to, or addition to the second cam 1985. This can also help cushion seating of the valve as well as provide linear guidance. Additionally, in this example, the spring 1972.4 can be mounted in a cylindrical housing, which can corporate with an external guide, to help ensure linear motion of the bridge is achieved. In any event, in this example, the first cam 1981 is profiled so as to determine the parameters of the valve in respect to the required dwell angle and lift height. The first cam 1981 controls the cycle parameters set for the valves throughout the entire operation cycle and in particular, determine the closure of the valve and the amount of pressure placed on the valve seat by the closing valve. The first cam 1981 also determines the height of lift and the manner in which lift and return of the valve to the valve seat is performed, whilst the second cam 1985 operates to open the valve, and prevent the valve closing unintentionally.

It will be appreciated that in the above described the first and second cams 1981, 1985 operate in conjunction to positively close and open the valve, thereby avoiding the need for separate biasing means, such as springs, or the like. The particular arrangement used has a number of benefits.

Firstly, by providing the cams 1981, 1985 within the opening of the bridge 1970, this allows the cam followers to be provided on opposite sides of the opening, so that the first and second cam followers 1977, 1979 positively urge the bridge in opposite directions. This allows for completely linear movement and thereby avoids the inefficiencies and additional wear caused by the use of rocker arms and pivots.

Second this allows the cams top be provided coaxially on a common camshaft, which ensures perfect synchronisation of the first and second cams. This can help prevent timing issues experienced in some engines.

Thirdly, in the configuration shown, the second cam 1985 is smaller that the first cam 1981. This allows the camshaft 1980 and cams 1981, 1985 to be machined from a single body. In this regard, a rod of material can initially be machined to the profile of the first cam 1981, with regions intermediate the locations of the first cams being further machined in order to create the second cams 1985.

Furthermore, in the current example, the second cam 1985 and second cam follower 1979 are aligned with the bridge 1970, whilst the first cam 1981 and first cam follower 1977 are offset from the bridge 1970. Additionally, in this example, two first cams 1981 and two second followers 1977 are mounted symmetrically on either side of the bridge 1970 to thereby ensure that forces on the bridge are balanced, thereby reducing wear and increasing efficiency. It will be appreciated that this is not essential and any suitable arrangement could be used, including for example providing any number of first or second cams 1981, 1985 and corresponding cam follower 1977, or by providing each of the first and second cams 1981, 1985 and cam followers 1977, 1979 within the bridge so that none of these are offset from the bridge 1970.

Additionally, in this example, the bridge 1970 is formed from two bridge portions to facilitate assembly within an engine or other piston machine. This allows the valve seal 1964 top be installed in the head of the engine, with the first bridge portion 1971 being mounted, the camshaft positioned, before the second bridge portion 1972 is coupled to the first bridge portion 1971. This also allows for adjustment of the bridge, for example to provide variable tensioning, to thereby accommodate stretch of the valve seat following extended use. In particular, such adjustment need only be made using the second bridge portion 1972, which is typically more accessible within an engine, making the adjustment process more straightforward.

In one example, this can be achieved using an adjustable section 1972.2 of the second bridge portion 1972 that can be moved relative to the remainder of the second bridge portion 1972 thereby allowing the position of the cam follower 1977 to be adjusted. However, it will be appreciated that adjustment could also be provided without the use of a bridge having two bridge portions, for example using shimming or the like.

Additionally, the second bridge portion 1972 can incorporate a spring 1972.3, such as a wave spring or other biasing mechanism, for urging the first cam follower 1977 in the second direction 1922 towards the first cam 1981. This can provide a number of benefits, including ensuring positive engagement between the first cam follower 1977 and first cam 1981. This also provides a buffer for the transition between cam lobes, which can help reduce valve chatter, as well as making the arrangement easier to manufacture by allowing for greater tolerances in production, and good for wear & adjustability. This also helps cushion valve closure, which in turn helps reduce valve seat wear. It will be appreciated that this can be achieved in a straightforward manner, which would not otherwise be the case in non-linear arrangements. It will be appreciated that similar benefits could be obtained by providing the spring 1972.3 in the first bridge portion 1971 for urging the second cam follower 1979 towards the second cam 1985, or by providing springs or other biasing mechanisms associated with both of the first and second cam followers 1977, 1979.

The above described arrangement can be further expanded to include multiple inline valve arrangements, with a number of bridges 1970 operated via a common camshaft extending through the opening O of each bridge 1970. This provides the ability to actuate multiple valves simultaneously, with timing being easily synchronised between the valves based on the camshaft configuration. In this regard, the camshaft can be formed from a single unitary body, this prevents drift in the relative timing of the valves, thereby ensuring the valves operate in synchronisation, even after prolonged use.

Accordingly the above example describes a valve arrangement for use in a piston machine, which includes a valve for operatively controlling fluid flow through a port, a bridge coupled to the valve so that linear movement of the bridge in a first direction causes the valve to close and linear movement of the bridge in a second direction causes the valve to open, a closing actuator including a rotatable first cam having a first cam lobe, and wherein upon rotation of the first cam, the first cam lobe urges the bridge in the first linear direction to thereby positively close the valve and, an opening actuator for causing the bridge to move in the second direction to thereby at least positively open the valve.

This provides a mechanism for allowing the bridge to be used to achieve linear opening of the valve, which can reduce wear and increase efficiency of operation.

In one example, the valve arrangement includes a first cam follower mounted on the bridge, the first cam follower cooperating with the first cam to cause movement of the bridge in the first linear direction. Alternatively however the cam could engage the bridge directly without requiring a separate discrete follower.

In either case, the first cam is positioned between the first cam follower (or portion of the bridge that is engaged by the cam) and the valve, allowing for linear motion of the bridge in the first direction away from the valve to be used to close the valve. This allows the cam lobe to ensure positive closure of the valve allowing for more reliable valve closure.

In one example, the first cam follower is movably mounted to the bridge. This can be used either to allow the first cam follower to be urged in the second direction relative to the bridge by a biasing spring, to provide tolerances in the arrangement, or to allow the position of the first cam follower to be adjusted in either the first or second direction to thereby adjust a degree of valve lift. Alternatively, a similar effect could be achieved by movably mounting and/or biasing the second cam follower relative to the bridge.

The opening actuator typically includes a rotatable second cam having a second cam lobe, and wherein upon rotation of the second cam, the second cam lobe urges the bridge in the second linear direction to thereby positively open the valve. However, alternatively a biasing spring could be used.

In the case of the use of the second cam, the valve arrangement typically includes a second cam follower mounted on the bridge, the second cam follower cooperating with the second cam to cause movement of the bridge in the second linear direction. In this case, the second cam follower is usually positioned between the second cam and the valve.

In this arrangement, the second cam can be mounted coaxially and rotationally invariant with the first cam, for example by providing the first and second cams on a common camshaft. This can be achieved by manufacturing the cams and attaching these to the camshaft, but more typically the first and second cams are integrally formed as part of the camshaft.

The valve arrangement can include at least two first cams spaced apart along a common camshaft, the at least two first cams cooperating with corresponding at least two first cam followers mounted on the bridge. This can be used to balance forces applied to the bridge.

Alternatively, the valve arrangement can include at least two second cams spaced apart along a common camshaft, the at least two second cams cooperating with corresponding at least two second cam followers mounted on the bridge.

In a further example, the second cam lobe further restricts movement of the bridge in the first linear direction when first cam lobe is not urging the bridge in the first linear direction.

In one example, the valve arrangement includes first and second bridge portions. Whilst not essential, this can be advantageous in terms of construction and maintenance of the valve arrangement, for example by making access to the valve components more straightforward.

In this example, the first and second bridge portions define an opening therebetween, a camshaft extending through the opening in use. Additionally, the valve can be coupled to the first bridge portion and wherein the valve arrangement includes a first cam follower mounted on the second bridge portion and a second cam follower coupled to the first bridge portion.

The valve arrangement can include at least one cam and cam follower laterally offset from the bridge and more typically cams and cam followers are mounted symmetrically on either side of the bridge to balance forces applied to the bridge.

The valve arrangement also typically includes a plurality of valves, bridges, and opening actuators in a spaced apart arrangement, each opening actuator including at least one first cam, each first cam being mounted on a common camshaft.

Accordingly, it will be appreciated that the above described techniques, and in particular the valve control processes can apply to any piston machine, including but not limited to reciprocating engines, compressors or the like.

In this regard, such a piston machine typically includes a rotating shaft, a housing defining an internal chamber, a piston positioned in the chamber, the piston being connected to the shaft and being configured to move inside the chamber as the shaft rotates, a port provided in the housing for allowing fluid communication between the chamber and a respective manifold and a valve arrangement including a valve for operatively controlling fluid flow through the port, a bridge coupled to the valve, wherein movement of the bridge in a first direction causes the valve to close and movement of the bridge in a second direction causes the valve to open, a closing actuator for causing the bridge to move in the first direction based on the reciprocation of the piston, to thereby positively close the valve and at least one biasing member for biasing the bridge towards the second direction.

The above described arrangement provides particular operation efficiencies. In particular, the actuator is used to positively close the valve, as opposed to using a biasing spring to urge a valve closed, as is the case in traditional piston engine/compressor arrangements. In this case, a much weaker spring can be used to open the valve, so that overall the energy required to open and close the valve is significantly reduced compared to standard valve arrangements.

It will be appreciated that in one example this is achieved using a cam having an elongated lobe allowing for lifting of the bridge, and hence closing of the valve, for a large part of the cam rotation cycle. Thus, mechanically closing the valve, and then using a weaker spring to allow for opening of the valves increases energy efficiency. This increase in efficiency can be as much as 6-8% in combustion engines, and potentially significantly more in other applications.

Another benefit of the above described arrangement is that use of the bridge allows for linear actuation of the valve. In particular, a rotational cam can be used to cause linear movement of the bridge, further leading to linear movement of the valve. Thus, as described above, this can lead to further improvements in energy efficiency and wear characteristics.

It will be appreciated from this that the above described arrangements can also relate to a valve arrangement for use in a piston machine, the valve arrangement including a valve for operatively controlling fluid flow through a port, a bridge coupled to the valve, wherein linear movement of the bridge in a first direction causes the valve to close and linear movement of the bridge in a second direction causes the valve to open, a closing actuator including a rotatable cam having a cam lobe, and wherein upon rotation of the cam, the cam lobe urges the bridge in the first linear direction to thereby positively close the valve and at least one biasing member for biasing the bridge in the second linear direction so that the at least one biasing member opens the valve when the valve is not positively closed by the actuator.

It will also be appreciated that the above described techniques could be applied to piston machines with groups of valves. In this example, the piston machine includes a rotating shaft, a housing defining an internal chamber, a piston positioned in the chamber, the piston being connected to the shaft and being configured to move inside the chamber as the shaft rotates, a head attached to the cylinder and closing the chamber at an end opposing the piston, the head including at least one port group including two or more ports for allowing fluid communication between the chamber and a respective manifold and for each port group, a valve arrangement coupled to the head, each valve arrangement including, for each port of the port group, a valve for operatively controlling fluid flow through the respective port, a bridge coupled to the valves, wherein movement of the bridge relative to the head causes synchronised operation of the valves and an actuator for causing the bridge to move.

It will be appreciated that the above described valve arrangements can be used in wide range of applications, including but not limited to air engines of a two stroke design or internal combustion engines of a four stroke design, as well as to compressors or the like.

The valve arrangements can include different numbers of lobes, depending on the preferred implementation. For example, when used in two stoke arrangements, the cams typically have one lobe per valve set, whereas in four stroke designs two or more, and more typically three lobes per valve or valve set can be used.

It will be appreciated that many components are interchangeable between different applications, so for example the multi-sectional crankshaft and/or twin armed connecting rod used in the air engine can be used in an IC engine.

The system can be used with a wide range of valve configurations, including but not limited to both inverted and standard valves. In one particular example, lifting the bridge away from the head will close the valves and that lowering the bridge towards the head will open the valves in both air and IC engines.

The system can easily accommodate varying tension of the valve stem, making it more straightforward to adjust valve arrangements to accommodate stretch of the valve seat/push rod arrangement. Additionally, a built in tensioning device can be used to compensate for valve stem expansion created by heat of the IC engine as it operates.

The arrangement can be used within a single valve or multiple valve set, driven by a common camshaft, thereby ensuring timing between multiple valves can be maintained.

The valve arrangement can be used on reciprocating compressors to improve efficiency, particularly in a 2 stroke format. In this example, biasing devices may be used due to two stroke operation and lower internal chamber pressures. In contrast, in IC engines such biasing may not be required, and instead a “kicker” arrangement could be used to facilitate opening of the valve, although again, this may not be required. When used, a kicker cam performs opening but is reliant upon the parameters of the main cam lobe to determine the motion of the bridge and hence the timing of the valve or valves.

In one particular arrangement, the use of the bridge is particularly beneficial as it allows the followers to be provided substantially inline with the valve stem axis, meaning that motion is linear and hence reducing wear and improving efficiency, as previously discussed.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1-48. (canceled)

49. A reciprocating engine including:
a) a crankshaft;
b) a cylinder defining an internal chamber;
c) a piston positioned in the chamber, the piston being connected to the crankshaft and being configured to reciprocate inside the chamber;
d) a head attached to the cylinder and closing the chamber at an end opposing the piston, the head including a port for allowing fluid communication between the chamber and a respective manifold; and,
e) a valve arrangement including:
i) a valve for operatively controlling fluid flow through the port;
ii) a bridge coupled to the valve, wherein movement of the bridge in a first direction causes the valve to close and movement of the bridge in a second direction causes the valve to open;
iii) a closing actuator for causing the bridge to move in the first direction based on the reciprocation of the piston, to thereby positively close the valve; and,
iv) at least one biasing member for biasing the bridge towards the second direction.

50. An engine according to claim 49, wherein the valve arrangement is configured so that the biasing member causes the valve to open when the closing actuator is not being used to positively close the valve.

51. An engine according to claim 49, wherein the closing actuator includes a cam mounted on a camshaft that is rotationally coupled to the crankshaft, the cam being configured to control the movement of the bridge depending on a rotational position of the crankshaft, the bridge including a cam follower for engaging the cam.

52. An engine according to claim 51, wherein the bridge includes a first bridge portion to which the valve is coupled and a second bridge portion including the cam follower.

53. An engine according to claim 52, wherein the bridge defines a cavity between the first bridge portion and the second bridge portion, the camshaft extending through the cavity.

54. An engine according to claim 49, wherein each biasing member is a spring coupled to the bridge.

55. An engine according to claim 54, wherein each spring is coupled to the bridge so that the spring is compressed when the bridge is moved in the first direction using the closing actuator to positively close the valve so that the compressed spring urges the bridge in the second direction to thereby open the valve when the closing actuator is not being used to positively close the valve.

56. An engine according to claim 54, wherein each spring is mounted on a stud extending outwardly from the head.

57. An engine according to claim 49, wherein the valve arrangement includes a pair of biasing members arranged symmetrically about the valve.

58. An engine according to claim 49, wherein the movement of the bridge in the first direction involves the bridge moving away from the head and the movement of the bridge in the second direction involves the bridge moving towards the head.

59. An engine according to claim 49, wherein the valve arrangement includes two or more valves coupled to the bridge, each valve being for operatively controlling fluid flow through a respective port, whereby movement of the bridge causes synchronized operation of the two or more valves.

60. An engine according to claim 49, wherein the engine is a pressurized gas engine configured to be driven by compressed gas.

61. An engine according to claim 49, wherein the engine is an internal combustion engine and further includes at least one of:
a) an ignition source;
b) a glow plug; and,
c) a fuel injector.

62. An engine according to claim 49, wherein the valve arrangement further includes an opening actuator for causing the bridge to move in the second direction based on the reciprocation of the piston, to thereby positively open the valve.

63. An engine according to claim 49, wherein the valve arrangement includes a seal breaking actuator for causing the bridge to move in the second direction to positively break a seal between the port and the valve after the valve is closed.

64. An engine according to claim 63, wherein the closing actuator includes a first cam mounted on a camshaft that is rotationally coupled to the crankshaft and the seal breaking actuator includes a second cam mounted on the same camshaft, the first and second cams being configured to control the movement of the bridge depending on a rotational position of the crankshaft.

65. An engine according to claim 64, wherein the first cam includes a first cam lobe and the second cam includes a second cam lobe, and wherein upon rotation of the camshaft, the first cam lobe urges the bridge in the first direction to thereby positively close the valve and the second cam lobe urges the bridge in the second direction to positively break the seal.

66. An engine according to claim 64, wherein the bridge includes a first cam follower for engaging the first cam and a second cam follower for engaging the second cam.

67. An engine according to claim 66, wherein the bridge includes:
a) a first bridge portion to which the valve is coupled, the first bridge portion including the second cam follower; and,
b) a second bridge portion including the first cam follower.

68. An engine according to claim 67, wherein the camshaft extends between the first and second bridge portions.

69. An engine according to claim 49, wherein the valve arrangement is configured such that the biasing member cushions the closing of the valve.

70. A piston machine including:
a) a rotating shaft;
b) a housing defining an internal chamber
c) a piston positioned in the chamber, the piston being connected to the shaft and being configured to move inside the chamber as the shaft rotates;
d) a port provided in the housing for allowing fluid communication between the chamber and a respective manifold; and,
e) a valve arrangement including:
i) a valve for operatively controlling fluid flow through the port;
ii) a bridge coupled to the valve, wherein movement of the bridge in a first direction causes the valve to close and movement of the bridge in a second direction causes the valve to open;
iii) a closing actuator for causing the bridge to move in the first direction based on the reciprocation of the piston, to thereby positively close the valve; and,
iv) at least one biasing member for biasing the bridge towards the second direction.

71. A piston machine according to claim 70, wherein the piston machine is at least one of a compressor and a reciprocating engine.

72. A valve arrangement for use in a piston machine, the valve arrangement including:
a) a valve for operatively controlling fluid flow through a port;
b) a bridge coupled to the valve, wherein linear movement of the bridge in a first direction causes the valve to close and linear movement of the bridge in a second direction causes the valve to open;
c) a closing actuator including a rotatable cam having a cam lobe, and wherein upon rotation of the cam, the cam lobe urges the bridge in the first linear direction to thereby positively close the valve; and,
d) at least one biasing member for biasing the bridge in the second linear direction so that the at least one biasing member opens the valve when the valve is not positively closed by the actuator.

73. A valve arrangement for use in a piston machine, the valve arrangement including:
a) a valve for operatively controlling fluid flow through a port;
b) a bridge coupled to the valve, wherein linear movement of the bridge in a first direction causes the valve to close and linear movement of the bridge in a second direction causes the valve to open;
c) a closing actuator including a rotatable first cam having a first cam lobe, and wherein upon rotation of the first cam, the first cam lobe urges the bridge in the first linear direction to thereby positively close the valve; and,
d) an opening actuator for causing the bridge to move in the second direction to thereby at least positively open the valve.

74. A valve arrangement according to claim 73, wherein the valve arrangement includes a first cam follower mounted on the bridge, the first cam follower cooperating with the first cam to cause movement of the bridge in the first linear direction.

75. A valve arrangement according to claim 74, wherein the first cam is positioned between the first cam follower and the valve.

76. A valve arrangement according to claim 75, wherein the first cam lobe urges the first cam follower in the first linear direction away from the valve.

77. A valve arrangement according to claim 74, wherein the first cam follower is movably mounted to the bridge.

78. A valve arrangement according to claim 77, wherein the first cam follower is urged in the second direction relative to the bridge by a biasing spring.

79. A valve arrangement according to claim 77, wherein a position of the first cam follower in the first or second direction is adjusted to adjust a degree of valve lift.

80. A valve arrangement according to claim 73, wherein the opening actuator includes a rotatable second cam having a second cam lobe, and wherein upon rotation of the second cam, the second cam lobe urges the bridge in the second linear direction to thereby positively open the valve.

81. A valve arrangement according to claim 80, wherein the valve arrangement includes a second cam follower mounted on the bridge, the second cam follower cooperating with the second cam to cause movement of the bridge in the second linear direction.

82. A valve arrangement according to claim 81, wherein the second cam follower is positioned between the second cam and the valve.

83. A valve arrangement according to claim 80, wherein the second cam is mounted coaxially and rotationally invariant with the first cam.

84. A valve arrangement according to claim 80, wherein the valve arrangement includes first and second cams mounted on a common camshaft.

85. A valve arrangement according to claim 80, wherein the valve arrangement includes at least two first cams spaced apart along a common camshaft, the at least two first cams cooperating with corresponding at least two first cam followers mounted on the bridge.

86. A valve arrangement according to claim 80, wherein the valve arrangement includes at least two second cams spaced apart along a common camshaft, the at least two second cams cooperating with corresponding at least two second cam followers mounted on the bridge.

87. A valve arrangement according to claim 80, wherein the valve arrangement includes a plurality of first cams spaced apart along a common camshaft.

88. A valve arrangement according to claim 80, wherein the second cam lobe further restricts movement of the bridge in the first linear direction when first cam lobe is not urging the bridge in the first linear direction.

89. A valve arrangement according to claim 73, wherein the opening actuator includes a spring for biasing the valve in the second linear direction.

90. A valve arrangement according to claim 73, wherein the bridge includes first and second bridge portions.

91. A valve arrangement according to claim 90, wherein the first and second bridge portions define an opening therebetween, a camshaft extending through the opening in use.

92. A valve arrangement according to claim 90, wherein the valve is coupled to the first bridge portion and wherein the valve arrangement includes a first cam follower mounted on the second bridge portion.

93. A valve arrangement according to claim 92, wherein the valve arrangement includes a second cam follower coupled to the first bridge portion.

94. A valve arrangement according to claim 73, wherein the valve arrangement includes at least one cam and cam follower laterally offset from the bridge.

95. A valve arrangement according to claim 73, wherein the valve arrangement includes a plurality of valves, bridges, and opening actuators in a spaced apart arrangement, each opening actuator including at least one first cam, each first cam being mounted on a common camshaft.

96-97. (canceled)
